(19) United States
(12) Patent Application Publication
(10) Pub. No.: US 2025/0063575 A1
(43) Pub. Date: Feb. 20, 2025

(54) USER EQUIPMENT AND METHOD FOR HIGH PRECISION SIDELINK POSITIONING

(71) Applicant: Fraunhofer-Gesellschaft zur Förderung der angewandten Forschung e.V., München (DE)

(72) Inventors: Dariush MOHAMMAD SOLEYMANI, Erlangen (DE); Martin LEYH, Erlangen (DE); Elke ROTH-MANDUTZ, Erlangen (DE); Mehdi HAROUNABADI, Erlangen (DE); Dietmar LIPKA, Erlangen (DE); Mohammad ALAWIEH, Erlangen (DE); Bastian PERNER, Erlangen (DE); Norbert FRANKE, Erlangen (DE); Birendra GHIMIRE, Erlangen (DE); Melanie LIPKA, Erlangen (DE)

(73) Assignee: Fraunhofer-Gesellschaft zur Förderung der angewandten Forschung e.V., München (DE)

(21) Appl. No.: 18/757,514

(22) Filed: Jun. 28, 2024

Related U.S. Application Data
(63) Continuation of application No. PCT/EP2022/087801, filed on Dec. 23, 2022.

(30) Foreign Application Priority Data
Dec. 29, 2021 (EP) 21218238.0

(51) Int. Cl. H04W 72/25; H04W 64/00; H04W 72/40; H04W 72/51

(52) U.S. Cl. CPC H04W 72/25; H04W 64/00; H04W 72/40; H04W 72/51

(57) ABSTRACT

A first user equipment of a wireless communication system is provided. After a second user equipment of the wireless communication system has transmitted a first signal, being a reference or control or data signal, to the first user equipment via a sidelink between the second and first user equipment, the first user equipment is configured to receive said reference or control or data signal as a second signal from the second user equipment via the sidelink. The first user equipment is configured to determine positioning information depending on difference information, such that the difference information has information on difference(s) between the first signal, transmitted by the second user equipment, and the second signal, received by the first user equipment. The positioning information has information on a distance and/or a distance change between the first and the second user equipment and/or a position of the first user equipment and/or the second user equipment and/or an angle which depends on the position of the first and the second user equipment.

### CROSS-REFERENCE TO RELATED APPLICATIONS

This application is a continuation of copending International Application No. PCT/EP2022/087801, filed Dec. 23, 2022, which is incorporated herein by reference in its entirety, and additionally claims priority from European Application No. 21218238.0, filed Dec. 29, 2021, which is also incorporated herein by reference in its entirety.

### TECHNICAL FIELD

The present invention relates to the field of wireless communication systems or networks, more specifically to an apparatus and a method for providing high precision sidelink positioning.

### BACKGROUND OF THE INVENTION

FIG. 1A and FIG. 1B are schematic representations of an example of a terrestrial wireless network 100 including, as is shown in FIG. 1A, the core network and one or more radio access networks RAN₁, RAN₂, . . . RAN_{N} (RAN=Radio Access Network). FIG. 1B is a schematic representation of an example of a radio access network RANn that may include one or more base stations gNB₁ to gNB₅ (gNB=next generation Node B), each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT (Internet of Things) devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANn may include more or less such cells, and RANn may also include only one base station. FIG. 1B shows two users UE₁ and UE₂, (UE=User Equipment) also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1B shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base stations gNB₁ to gNB₅ may be connected to the core network 102, e.g. via the S1 interface, via respective backhaul links 114₁ to 114₅, which are schematically represented in FIG. 1B by the arrows pointing to “core”. The core network 102 may be connected to one or more external networks. The external network may be the Internet or a private network, such as an intranet or any other type of campus networks, e.g. a private WiFi or 4G or 5G mobile communication system. Further, some or all of the respective base stations gNB₁ to gNB₅ may be connected, e.g. via the S1 or X2 interface or the XN interface in NR (New Radio), with each other via respective backhaul links 116₁ to 116₅, which are schematically represented in FIG. 1B by the arrows pointing to “gNBs”. A sidelink channel allows direct communication between UEs, also referred to as device-to-device, D2D (Device to Device), communication. The sidelink interface in 3GPP (3G Partnership Project) is named PC5 (Proximity-based Communication 5).

For data transmission a physical resource grid may be used. The physical resource grid may comprise a set of resource elements to which various physical channels and physical signals are mapped. For example, the physical channels may include the physical downlink, uplink and sidelink shared channels, PDSCH (Physical Downlink Shared CHannel), PUSCH (Physical Uplink Shared Channel), PSSCH (Physical Sidelink Shared Channel), carrying user specific data, also referred to as downlink, uplink and sidelink payload data, the physical broadcast channel, PBCH (Physical Broadcast Channel), carrying for example a master information block, MIB, and one or more of a system information block, SIB, one or more sidelink information blocks, SLIBs, if supported, the physical downlink, uplink and sidelink control channels, PDCCH (Physical Downlink Control Channel), PUCCH (Physical Uplink Control CHannel), PSCCH (Physical Sidelink Control Channel), the downlink control information, DCI, the uplink control information, UCI, and the sidelink control information, SCI, and physical sidelink feedback channels, PSFCH (Physical sidelink feedback channel), carrying PC5 feedback responses. Note, the sidelink interface may support a 2-stage SCI (Speech Call Items). This refers to a first control region comprising some parts of the SCI, and, optionally, a second control region, which comprises a second part of control information.

For the uplink, the physical channels may further include the physical random-access channel, PRACH (Packet Random Access Channel) or RACH (Random Access Channel), used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols (OFDM=Orthogonal Frequency-Division Multiplexing) depending on the cyclic prefix, CP, length. A frame may also include of a smaller number of OFDM symbols, e.g. when utilizing a shortened transmission time interval, sTTI (slot or subslot transmission time interval), or a mini-slot/non-slot-based frame structure comprising just a few OFDM symbols.

The wireless communication system may be any single-tone or multicarrier system using frequency-division multiplexing, like orthogonal frequency-division multiplexing, OFDM, or orthogonal frequency-division multiple access, OFDMA (Orthogonal frequency-division multiple access), or any other IFFT-based signal (IFFT=Inverse Fast Fourier Transformation) with or without CP, e.g. DFT-s-OFDM (DFT=discrete Fourier transform). Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1A and FIG. 1B may be a heterogeneous network having distinct overlaid networks, e.g., a network of macro cells with each macro cell including a macro base station, like base stations gNB₁ to gNB₅, and a network of small cell base stations, not shown in FIG. 1A and FIG. 1B, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1A and FIG. 1B, for example in accordance with the LTE-Advanced Pro standard or the 5G or NR, new radio, standard.

In mobile communication networks, for example in a network like that described above with reference to FIG. 1A and FIG. 1B, like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, or roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

Accurate positioning is a key element for safety critical automotive use cases, like the categories of connected, assisted, autonomous or tele-operated driving. Positioning comprises simple one-dimensional distance measurement, two dimensional distance in lateral and longitudinal direction, three-dimensional distance adding the height coordinate relative to an object as well as absolute position in two or even three dimensions, e.g. given by geo-coordinates. For example for Vehicle to Everything (V2X), the third dimension is needed in use cases where the trajectories of road users (RU) like vehicles cross on different levels. For example, a car should not initiate an emergency brake if another car crosses its way on a bridge route above and vice versa.

In a wireless communication network, like the one depicted in FIG. 1A and FIG. 1B, it may be desired to locate a UE with a certain accuracy, e.g., determine a position of the UE in a cell. Several positioning approaches are known, like satellite-based positioning approaches, e.g., autonomous and assisted global navigation satellite systems, A GNSS (Global Navigation Satellite System), such as GPS, mobile radio cellular positioning approaches, e.g., observed time difference of arrival, OTDOA, and enhanced cell ID, E-CID, or combinations thereof.

GNSS and radio access network (RAN) based positioning are well established state of the art. However, these systems require coverage by satellites respectively mobile network cells. On-board sensors are the classical tool for relative positioning today, independent from GNSS or mobile network coverage.

Sidelink is designed to operate in-coverage, partial coverage, and out-of-coverage (OOC) and is therefore a native candidate for relative positioning. Furthermore, absolute sidelink positioning is possible by involving anchor devices with fixed location, like road side units (RSU), or mobile devices that know their position by other means, e.g. GNSS. Sidelink positioning would enhance localization accuracy when fused together with other on-board sensors, where the term “sidelink positioning” stands for “anything that can be measured on the sidelink which is used to determine a position and enhance the overall positioning result”. It can enhance Uu and GPS absolute positioning if the required accuracy cannot be achieved, even when GNSS or the mobile network coverage are not available. It provides mechanisms to enhance advanced use cases such as V2X positioning scenarios including VRU (vulnerable road user) and traffic supervision by complementing on-board sensors.

Sidelink positioning demands new or enhanced positioning method that fits new 5G V2X use cases, e.g. defined in [2]. It can provide additional input to the conventional sensor-based positioning to complement/enhance the current positioning methods to fulfill the stringent requirement needed for new 5G use cases. It will thus enable accurate positioning independent of network or RAT coverage status (i.e. in or outside of network coverage) and thus offer critical reliability support for advanced applications. Sidelink (SL) based positioning can utilize unlicensed spectrum, without interrupting existing V2X deployments. It provides significantly improved accuracy for relative or absolute positioning in V2X, e.g. Vehicle to Vehicle (V2V), Vehicle to Infrastructure (V21) vehicle positions e.g. on the basis of UE-type-RSU signals and Vehicle to Pedestrian (V2P) scenarios, thus significantly reducing the number and severity of accidents between vehicles and pedestrians. Such safety critical scenarios require below meter level accuracy, e.g. 0.1 m with 3 sigma for automated driving related use cases.

The basic principle of a distance measurement is to transmit a reference signal (RS) and cross-correlate it with a replica of the RS at the receiver. A distance can then be estimated from the time position of the cross-correlation peak by considering the speed of light. The precision or accuracy of this estimation is impacted by noise and interference and by multipath propagation of the signal.

In the simpler case of a single propagation path the width of the cross-correlation peak is inversely proportional to the bandwidth of the signal, e.g. sidelink or any other signal like uplink (UL) or downlink (DL). To demonstrate this relationship, the spectrum of a sidelink can be modelled and approximated by a rectangular function. Assume all subcarriers in this spectrum are used for reference signals with equal amplitude, i.e. they are known to transmitter (TX) and receiver (RX). After reception, this signal is cross-correlated with a replica of the transmitted reference signal yielding a Sinc-shaped (sin (x)/x) impulse response. As an example, FIG. 2 shows the impulse response for the bandwidths of 10 MHZ (left) and 20 MHz (right).

As can be seen, doubling the bandwidth reduces the pulse width in the time domain to one half. At the first glance it seems that estimating the correct position of the peak maximum is not dependent on the bandwidth. However, adding noise and interference causes random deviations from the ideal curves in FIG. 2 with a probability distribution, like Gaussian. The time uncertainty then depends on an assumption for the definition of the pulse width using the variance.

In the more difficult case of multipath propagation, the task is to estimate the location of the peak in time of the LOS path (representing the wanted distance) which is normally the first peak. The goal is to distinguish it from later arriving paths that normally arise from multipath (reflections). A greater bandwidth helps to separate the arriving paths. For lower bandwidth, they would earlier (even for longer multipath deviations) blend into each other and could not be distinguished. The minimum distance where two peaks can be distinguished is called time resolution.

FIG. 3 illustrates a resolution of two mutually time shifted impulse responses, double pulse, at resolution limit (lower part). For a first basic analysis, time resolution can be modelled by the sum of two mutually time shifted pulses. If the time distance between the pulses is sufficiently high, the function of this double pulse exhibits two peaks with a valley in between as shown in the upper part of FIG. 3. If their distance is decreased the valley disappears at the resolution limit and the two pulses merge into one as shown in the lower part of FIG. 3. The time shift where they can be just distinguished is the resolution.

The resolution can be computed from the curvature of the function in the middle of the two pulses, i.e. its second derivative. If a valley is visible, as in FIG. 3 upper part, the second derivative is positive, if the pulses merge into one it is negative. Consequently, the resolution limit is reached if the second derivative is zero (as in the lower part of FIG. 3).

FIG. 4 illustrates a second derivative of two 10 MHz pulses evaluated in the middle between the two pulses. The first zero crossing marks the case where the two pulses merge, as shown in FIG. 3, lower part. In particular, FIG. 4 shows the second derivative in the middle between two pulses versus their mutual time shift for a bandwidth of 10 MHZ. In the region with negative 2. derivative below the first zero at 0.13 μs, the two pulses cannot be resolved. For time shifts greater than that, the two pulses split apart and can be distinguished. With the speed of light the time shift of 0.13 μs is translated into spatial distance of about 39.76 m. That means, a bandwidth of 400 MHz would be required to obtain a resolution of 1 m.

Indeed, resolution is always more pessimistic than timing accuracy given by noise in combination with pulse shapes as shown in FIG. 2, since noise and interference is always present. However, the model above is the worst case for multipath, so that time delay estimations in practice are usually more precise. Thus, statements from different sources indicate that an accuracy of less than 1 m can be achieved with a bandwidth of more than 100 MHz.

In Europe, currently 70 MHz are reserved for V2X on the 5.9 GHz band. However, they need to be split for 892.11p and C-V2X LTE and NR. Therefore, sidelink carrier bandwidths in typical bands, e.g. ITS bands, are expected to be rather limited to e.g. only 10 MHz or 20 MHz. Consequently, according to the above description precisions in the sub meter region seem to be not feasible. This IPR describes methods how to achieve much higher precision.

Currently, i.e. up to 5G NR release 17, 3GPP has not specified the support of positioning on sidelink.

FIG. 5A shows an example of a known 5G NR positioning wireless network architecture (see [3]), which is based on the Uu interface. Moreover, FIG. 5B illustrates a wireless network or communication system based on the Uu interface, which may be a terrestrial heterogeneous network having distinct overlaid networks, e.g., a network of macro cells with each macro cell including a macro base station, like base stations BS1 to BS4, and a network of small cell base stations, not shown in FIG. 5A, like femto or pico base stations. Further, non-terrestrial wireless communication networks (NTN) exist, including spaceborne transceivers, like satellites, and/or airborne transceivers, like unmanned aircraft systems.

The network entitie(s) which are essentially involved in computing the position of a UE are part of the core network and include the location management function (LMF) and the Access and Mobility Management Function (AMF). LMF and AMF communicate using the Network Layer Signaling protocol (NL1).

A plurality of state of the art positioning methods are listed in [3]. These methods can be classified into non-RAN based and RAN based. Non-RAN positioning is provided by GNSS, WLAN, Bluetooth a terrestrial beacon system (TBS), or by sensors.

RAN based methods based on LTE are enhanced cell ID (eCID), and observed time difference of arrival (OTDOA)

NR extends positioning by the methods, for example, by NR enhanced cell ID (NR eCID), Multi-Round Trip Time Positioning (Multi-RTT), Downlink Time Difference of Arrival (DL-TDOA), Uplink Time Difference of Arrival (UL-TDOA), Downlink Angle-of-Departure (DL-AoD) or Uplink Angle-of-Arrival (UL-AoA), including Azimuth angle of arrival (A-AoA) and Zenith angle of arrival (Z-AoA).

All methods listed above strive to determine the position of a device in space, either in two or three dimensions, as precise as possible. Two kinds of fundamental measurements can be identified in these methods as basis for all positioning methods which obviously determine their precision, namely distance and/or angle measurements.

It is noted that the information in the above section is only for enhancing the understanding of the background of the invention and, therefore, it may comprise information that does not form conventional technology that is already known to a person of ordinary skill in the art.

Starting from the above, there may be a need for improvements or enhancements for a wireless communication system or network and its components.

### SUMMARY

An embodiment may have a first user equipment of a wireless communication system, wherein, after a second user equipment of the wireless communication system has transmitted a first signal, being a reference signal or a control signal or a data signal, to the first user equipment via a sidelink between the second user equipment and the first user equipment, the first user equipment is configured to receive said reference signal or said control signal or said data signal as a second signal from the second user equipment via the sidelink, wherein the first user equipment is configured to determine positioning information depending on difference information, such that the difference information has information on one or more differences between the first signal, which has been transmitted by the second user equipment, and the second signal, which has been received by the first user equipment, wherein the positioning information has information on a distance and/or a distance change between the first user equipment and the second user equipment and/or a position of the first user equipment and/or a position of the second user equipment and/or an angle which depends on the position of the first user equipment and on the position of the second user equipment.

According to another embodiment, a system may have: a first apparatus being a first user equipment of a wireless communication system, wherein, after a second user equipment of the wireless communication system has transmitted a first signal, being a reference signal or a control signal or a data signal, to the first user equipment via a sidelink between the second user equipment and the first user equipment, the first user equipment is configured to receive said reference signal or said control signal or said data signal as a second signal from the second user equipment via the sidelink, wherein the first user equipment is configured to determine positioning information depending on difference information, such that the difference information has information on one or more differences between the first signal, which has been transmitted by the second user equipment, and the second signal, which has been received by the first user equipment, wherein the positioning information has information on a distance and/or a distance change between the first user equipment and the second user equipment and/or a position of the first user equipment and/or a position of the second user equipment and/or an angle which depends on the position of the first user equipment and on the position of the second user equipment, and a second apparatus being the second user equipment.

According to another embodiment, a method may have the steps of: after a second user equipment of a wireless communication system has transmitted a first signal, being a reference signal or a control signal or a data signal, to a first user equipment via a sidelink between the second user equipment and the first user equipment, receiving, by the first user equipment, said reference signal or said control signal or said data signal as a second signal from the second user equipment via the sidelink, determining positioning information depending on difference information, such that the difference information has information on one or more differences between the first signal, which has been transmitted by the second user equipment, and the second signal, which has been received by the first user equipment, wherein the positioning information has information on a distance and/or a distance change between the first user equipment and the second user equipment and/or a position of the first user equipment and/or a position of the second user equipment and/or an angle which depends on the position of the first user equipment and on the position of the second user equipment.

Another embodiment may have a non-transitory digital storage medium having stored thereon a computer program for performing a method having the steps of: after a second user equipment of a wireless communication system has transmitted a first signal, being a reference signal or a control signal or a data signal, to a first user equipment via a sidelink between the second user equipment and the first user equipment, receiving, by the first user equipment, said reference signal or said control signal or said data signal as a second signal from the second user equipment via the sidelink, determining positioning information depending on difference information, such that the difference information has information on one or more differences between the first signal, which has been transmitted by the second user equipment, and the second signal, which has been received by the first user equipment, wherein the positioning information has information on a distance and/or a distance change between the first user equipment and the second user equipment and/or a position of the first user equipment and/or a position of the second user equipment and/or an angle which depends on the position of the first user equipment and on the position of the second user equipment, when the computer program is implemented by a computer or signal processor.

A first user equipment of a wireless communication system is provided.

After a second user equipment of the wireless communication system has transmitted a first signal, being a reference signal or a control signal or a data signal, to the first user equipment via a sidelink between the second user equipment and the first user equipment, the first user equipment is configured to receive said reference signal or said control signal or said data signal as a second signal from the second user equipment via the sidelink. Moreover, the first user equipment is configured to determine positioning information depending on difference information, such that the difference information comprises information on one or more differences between the first signal, which has been transmitted by the second user equipment, and the second signal, which has been received by the first user equipment. The positioning information comprises information on a distance and/or a distance change between the first user equipment and the second user equipment and/or a position of the first user equipment and/or a position of the second user equipment and/or an angle which depends on the position of the first user equipment and on the position of the second user equipment.

Moreover, a method is provided. The method comprises:
After a second user equipment (50) of a wireless communication system has transmitted a first signal, being a reference signal or a control signal or a data signal, to a first user equipment (100) via a sidelink between the second user equipment (50) and the first user equipment (100), receiving, by the first user equipment (100), said reference signal or said control signal or said data signal as a second signal from the second user equipment (50) via the sidelink. And:
Determining positioning information depending on difference information, such that the difference information comprises information on one or more differences between the first signal, which has been transmitted by the second user equipment, and the second signal, which has been received by the first user equipment.

The positioning information comprises information on a distance and/or a distance change between the first user equipment and the second user equipment and/or a position of the first user equipment and/or a position of the second user equipment and/or an angle which depends on the position of the first user equipment and on the position of the second user equipment.

Furthermore, a computer program for implementing the above described method, when the computer program is executed by a computer or signal processor, is provided.

Embodiments are provided which realize distance measurements based on time delay measurements using reference signals. In the time domain this may, e.g., correspond to the determination of the position of correlation peak(s), in the frequency domain on a phase trajectory over the measurement bandwidth, especially the identification of a phase ramp. A further refinement is possible with the phase of a carrier, which appears in the phase of a correlation peak in the time or an offset of the phase trajectory in the frequency domain.

Some embodiments provide means for high precision distance and angle measurements based on PC5 sidelink and the corresponding waveform which may, e.g., be Orthogonal Frequency Division Multiplexing (OFDM).

Some of the provided embodiments achieve high precision distance measurements based on the PC5 interface, and provide at least one of a PC5 based positioning architecture, positioning reference signals on a sidelink, bandwidth enhancement with carrier aggregation, positioning using a carrier phase, distributed antennas, and signaling and procedures on higher layers.

### BRIEF DESCRIPTION OF THE DRAWINGS

FIG. 1A and FIG. 1B illustrate schematic representations of an example of a terrestrial wireless network;

FIG. 2 illustrates impulse responses of rectangular spectra with bandwidth 10 MHz (left) and 20 MHz (right);

FIG. 3 illustrates a resolution of two mutually time shifted impulse responses;

FIG. 4 illustrates a second derivative of two 10 MHz pulses evaluated in the middle between the two pulses;

FIG. 5A illustrates an example of a known 5G NR positioning wireless network architecture, which is based on the Uu interface;

FIG. 5B illustrates a wireless positioning communication system;

FIG. 6 illustrates a first user equipment for determining positioning information according to an embodiment;

FIG. 7 illustrates the first user equipment for determining positioning information of FIG. 6 and a second user equipment, which transmits a signal to the first user equipment for determining the positioning information according to an embodiment;

FIG. 8 shows a possible positioning architecture based on the PC5 interface (sidelink) according to some embodiments;

FIG. 9 illustrates 100 MHz spectrum in a block with two 10 MHz carriers at the ends of the 100 MHz spectrum according to an embodiment;

FIG. 10 illustrates cross-correlation functions of two 10 MHz carriers at the ends of 100 MHz and a 100 MHz carrier according to an embodiment;

FIG. 11 illustrates receiving phases due to different carrier frequencies according to an embodiment;

FIG. 12 illustrates receiving phases due to different receive antenna positions according to an embodiment;

FIG. 13 illustrates an illustrative example of explicit or condition-based sharing ranging measurement according to an embodiment; and

FIG. 14 illustrates an example of a computer system on which units or modules as well as the steps of the methods described in accordance with the inventive approach may execute.

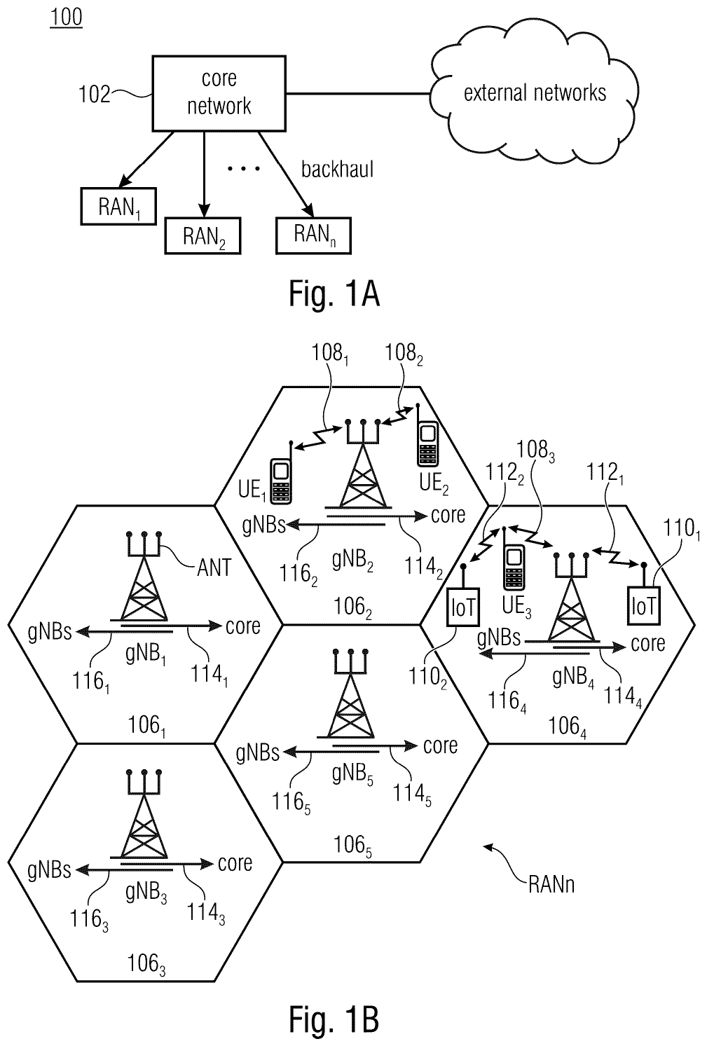

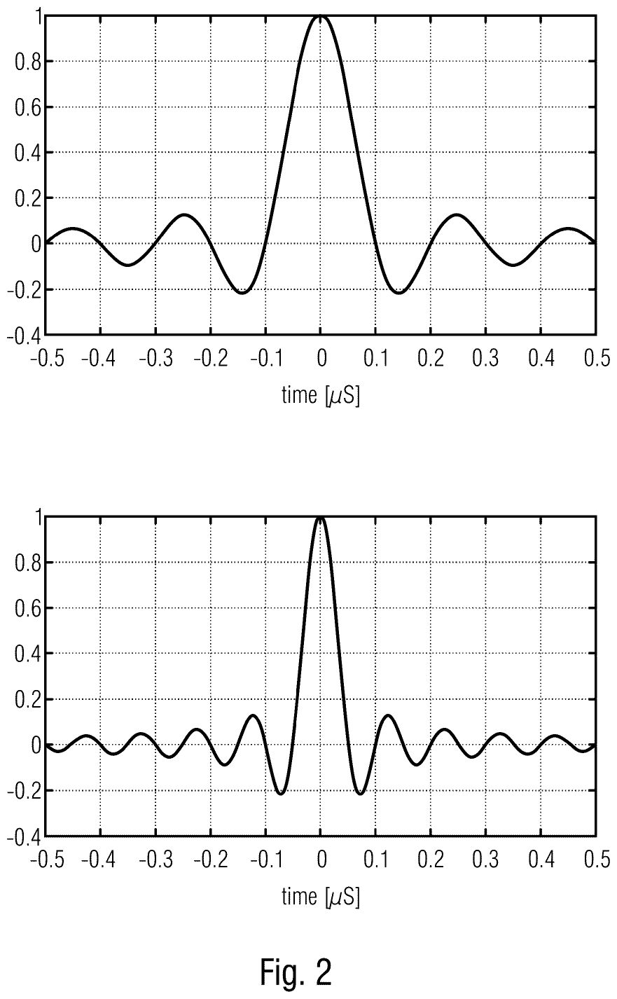

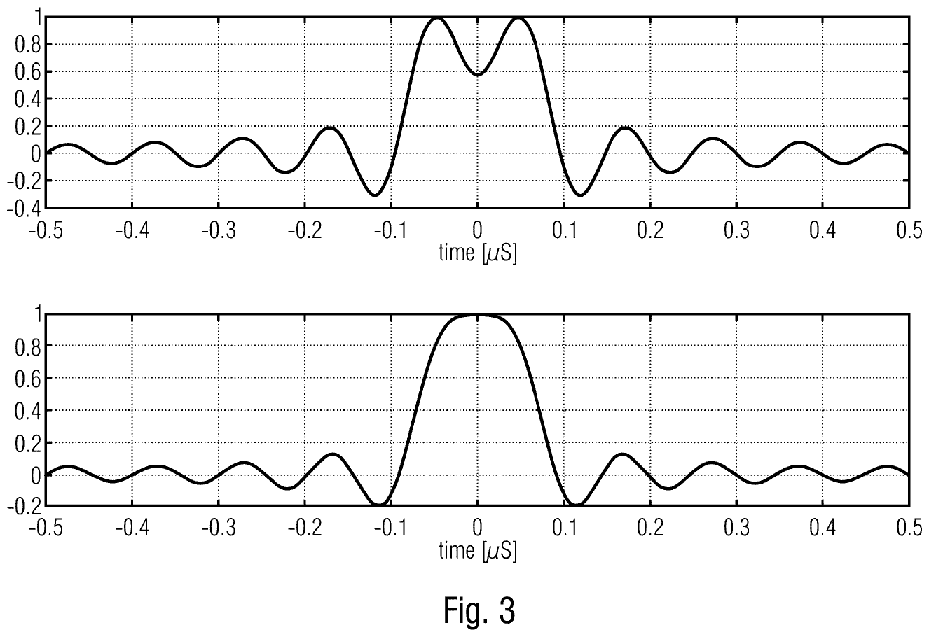

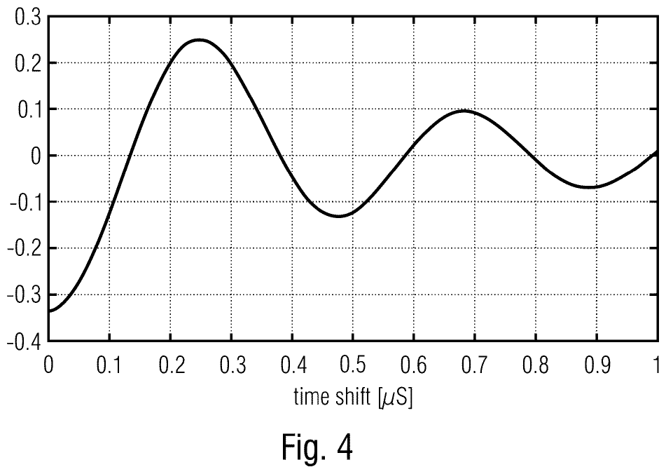

### DETAILED DESCRIPTION OF THE INVENTION

Embodiments of the present invention are now described in more detail with reference to the accompanying drawings, in which the same or similar elements have the same reference signs assigned.

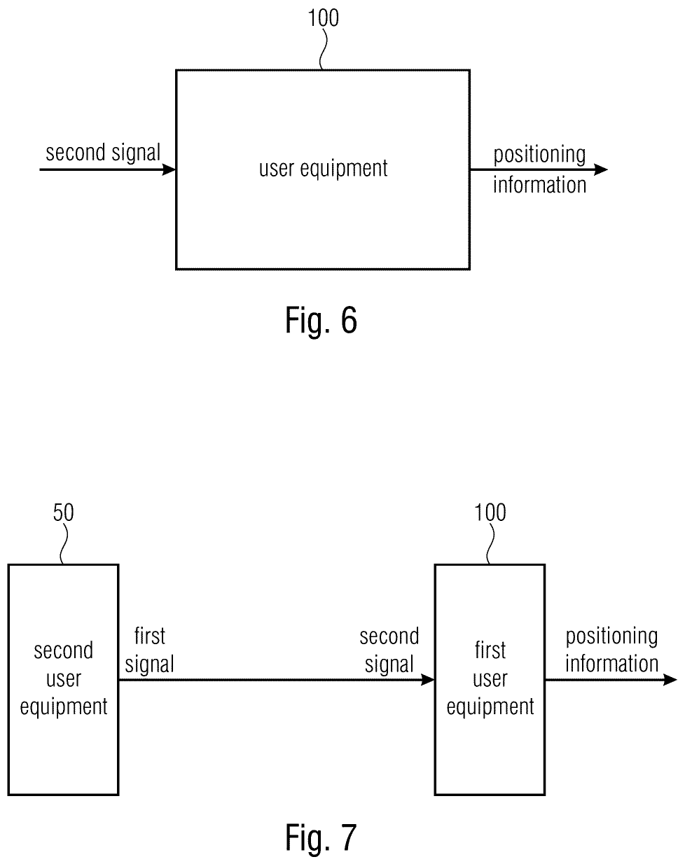

FIG. 6 illustrates a first user equipment 100 of a wireless communication system according to an embodiment.

After a second user equipment 50 of the wireless communication system has transmitted a first signal, being a reference signal or a control signal or a data signal, to the first user equipment 100 via a sidelink between the second user equipment 50 and the first user equipment 100, the first user equipment 100 is configured to receive said reference signal or said control signal or said data signal as a second signal from the second user equipment 50 via the sidelink.

Moreover, the first user equipment 100 is configured to determine positioning information depending on difference information, such that the difference information comprises information on one or more differences between the first signal, which has been transmitted by the second user equipment 50, and the second signal, which has been received by the first user equipment 100.

The positioning information comprises information on a distance and/or a distance change between the first user equipment and the second user equipment and/or a position of the first user equipment and/or a position of the second user equipment and/or an angle which depends on the position of the first user equipment and on the position of the second user equipment.

According to an embodiment, the first user equipment 100 may, e.g., be configured to conduct one or more measurements on one or more reference symbols or control symbols or data symbols of the second signal to obtain information on at least one difference of the one or more differences between the first signal, which has been transmitted by the second user equipment 50, and the second signal, which has been received by the first user equipment 100. The first user equipment 100 may, e.g., be configured to determine the positioning information depending on the information on said at least one difference.

In an embodiment, the first user equipment 100 may, e.g., be configured to transmit information on the one or more measurements to the second user equipment 50 via the sidelink.

According to an embodiment, the first user equipment 100 may, e.g., be configured to transmit information on the positioning information to the second apparatus or to one or more further apparatuses of the wireless communication system.

In an embodiment, the first user equipment 100 may, e.g., be configured to transmit the information on the positioning information in a unicast transmission.

According to an embodiment, the first user equipment 100 may, e.g., be configured to transmit the information on the positioning information in a broadcast transmission or groupcast transmission.

In an embodiment, the first user equipment 100 may, e.g., be configured to determine the positioning information using one of two or more positioning concepts selectable for the first user equipment 100. The first user equipment 100 may, e.g., be configured to select said one of the two or more positioning concepts to determine the positioning information.

According to an embodiment, the first user equipment 100 may, e.g., be configured to determine the positioning information using at least two different positioning concepts of the two or more positioning concepts selectable for the first user equipment 100.

In an embodiment, the first signal may, e.g., be a PS5-specific reference signal or a PS5-specific control signal or a PS5-specific data signal.

According to an embodiment, the first signal may, e.g., be one of
a demodulation reference signal
a signal sequence transported by a physical sidelink feedback channel,
a synchronization signal,
a sidelink positioning reference signal,
a phase-tracking reference signal,
a channel state information reference signal.

In an embodiment, the first signal may, e.g., be a sidelink positioning reference signal comprising one or more pseudo-random sequences and/or one or more constant amplitude zero autocorrelation sequences, or the first signal may, e.g., be a data transmit signal reconstructed from a decoded data signal, e.g., a Physical Sidelink Shared Channel (PSSCH). For example, the first user equipment 100 may, e.g., be configured to decode the data signal to obtain the decoded data signal.

According to an embodiment, the first user equipment 100 may, e.g., be configured to employ sidelink carrier aggregation using a plurality of frequency carriers.

In an embodiment, the first user equipment 100 may, e.g., be configured to receive said reference signal and/or said control signal and/or said data signal via the plurality of frequency carriers via a fragmented spectrum such that there exist at least two frequency carriers of the plurality of frequency carriers, which are employed for transmitting said reference signal, and/or said control signal, and/or said data signal, wherein each two of the at least two frequency carriers are spaced apart from each other in frequency, and wherein no other frequency carriers of the plurality of frequency carriers exist, which are employed for transmitting said reference signal and/or said control signal and/or said data signal, and which are located between said two of the at least two frequency carriers.

According to an embodiment, the fragmented spectrum may, e.g., comprise at least one of
multiple intra-band contiguous component carriers,
multiple intra-band non-contiguous component carriers,
multiple inter-band component carriers,
multiple resource pools,
multiple bandwidth parts.

In an embodiment, the plurality of carriers of the fragmented spectrum exhibit phase coherence with respect to each other.

According to an embodiment, the first signal is sparsely spread among the plurality of frequency carriers.

In an embodiment, for each frequency component of the two or more frequency components, the first signal depends on subcarriers of Orthogonal Frequency Division Multiplexing.

According to an embodiment, at least one of the one or more differences between the first signal and the second signal depends on a difference between a phase of the first signal, which has been transmitted by the second user equipment 50, and a phase of the second signal, which has been received by the first user equipment 100, wherein the first signal may, e.g., be the reference signal or may, e.g., be the control signal or may, e.g., be the data signal and/or the data signal may, e.g., be a reconstructed data signal. The reconstructed data signal may, e.g., be reconstructed from a decoded data signal. For example, the first user equipment 100 may, e.g., be configured to decode the data signal to obtain the decoded data signal and may, e.g., be configured to generate the reconstructed data signal from the decoded data signal.

In an embodiment, the first user equipment 100 may, e.g., be configured to determine said at least one of the one or more differences between the first signal and the second signal by combining the first signal and the second signal.

According to an embodiment, the first user equipment 100 may, e.g., be configured to receive two or more signals as two or more second signals in two or more frequency components transmitted from the second user equipment 50 of the wireless communication system via the sidelink between the first user equipment 100 and the second user equipment 50, wherein the two or more frequency components have different center frequencies, wherein the second user equipment 50 has transmitted said two or more signals as two or more first signals, wherein the two or more second signals comprise said second signal, and wherein the two or more first signals comprise said first signal. The first user equipment 100 may, e.g., be configured to determine the positioning information by determining difference information, wherein the difference information may, e.g., comprise information on one or more differences between the first signal and the second signal for each frequency component of the two or more frequency components. The two or more second signals may, e.g., comprise one or more reference signals and/or one or more control signals and/or one or more data signals, wherein, for each frequency component of the two or more frequency components, the first signal of said frequency component may, e.g., be a reference signal or may, e.g., be a control signal or may, e.g., be a data signal and/or the data signal may, e.g., be a reconstructed data signal. The reconstructed data signal may, e.g., be reconstructed from a decoded data signal. For example, the first user equipment 100 may, e.g., be configured to decode the data signal to obtain the decoded data signal and may, e.g., be configured to generate the reconstructed data signal from the decoded data signal.

In an embodiment, the first user equipment 100 may, e.g., be configured to determine the positioning information by determining difference information, wherein the difference information may, e.g., comprise information on a difference between a phase of the first signal and a phase of the second signal for each frequency component of the two or more frequency components.

According to an embodiment, for each frequency component of the two or more frequency components, the first user equipment 100 may, e.g., be configured to determine said at least one of the one or more differences between the first signal of said frequency component and the second signal of said frequency component by combining said first signal and said second signal.

In an embodiment, for each frequency component of the two or more frequency components, the first user equipment 100 may, e.g., be configured to combine the first signal of said frequency component and the second signal of said frequency component by determining a cross-correlation between said first signal and said second signal.

According to an embodiment, the first user equipment 100 may, e.g., be configured to receive the two or more second signals using two or more antennas of the first user equipment 100. And/or, the second user equipment 50 has employed two or more antennas of the second user equipment 50 to transmit the two or more first signals.

In an embodiment, the two or more antennas of the first user equipment 100 may, e.g., be three or more antennas, which form an antenna array which may, e.g., be at least two-dimensional. And/or, the two or more antennas of the second user equipment 50 may, e.g., be three or more antennas, which form an antenna array which may, e.g., be at least two-dimensional.

According to an embodiment, the first user equipment 100 may, e.g., be configured to determine the difference information by determining phase differences which depend on an employed bandwidth and a distance between the first user equipment 100 and the second user equipment 50 for each antenna of the two or more antennas. And/or, the first user equipment 100 may, e.g., be configured to determine the difference information by determining a carrier phase for each of the two or more frequency components, which depends on a distance between the first user equipment 100 and the second user equipment 50.

In an embodiment, the first user equipment 100 may, e.g., be configured to determine the difference information by employing a recursive approach or a recursive filter (for example, a Kalman filter).

According to an embodiment, the first user equipment 100 may, e.g., be configured to determine the positioning information by employing the difference information and by additionally employing information from a Global Navigation Satellite System and/or by additionally employing on-board sensors of the first user equipment 100.

In an embodiment, the first user equipment 100 may, e.g., be configured to synchronize itself with the second user equipment 50 by employing information from a Global Navigation Satellite System. Or, the first user equipment 100 may, e.g., be configured to synchronize itself with the second user equipment 50 by employing information from a base station. Or, the first user equipment 100 may, e.g., be configured to synchronize itself with the second user equipment 50 using a synchronization signal block transmitted by the second user equipment 50. Or, the first user equipment 100 may, e.g., be configured to synchronize itself with the second user equipment 50 using a synchronization signal block transmitted by another user equipment being different from the first user equipment 100 and from the second user equipment 50.

According to an embodiment, the first user equipment 100 may, e.g., be configured to transmit another first signal to the second user equipment 50 or to another user equipment to allow or support positioning. Said other first signal may, e.g., be another reference signal or another control signal or another data signal, wherein the other first signal may, e.g., be a reference signal or may, e.g., be a control signal or may, e.g., be a data signal and/or the data signal may, e.g., be a reconstructed data signal. The reconstructed data signal may, e.g., be reconstructed from a decoded data signal. For example, the first user equipment 100 may, e.g., be configured to decode the data signal to obtain the decoded data signal and may, e.g., be configured to generate the reconstructed data signal from the decoded data signal.

In an embodiment, the first user equipment 100 may, e.g., be configured to estimate a phase ramp and a carrier phase depending on the difference information comprising the information on the one or more differences between the first signal, which has been transmitted by the second user equipment 50, and the second signal, which has been received by the first user equipment 100. Moreover, the first user equipment 100 may, e.g., be configured to transmit said other first signal to the second user equipment 50, which may, e.g., be received by the second user equipment 50 as another second signal; wherein the first user equipment 100 may, e.g., be configured to transmit said other first signal by applying the phase ramp and the carrier phase, which has been estimated by the first user equipment 100, on said other first signal, or may, e.g., be configured to transmit information on the phase ramp and on the carrier phase to the second user equipment 50; wherein the first user equipment 100 may, e.g., be configured to transmit said other first signal with a predefined time delay, wherein said predefined delay may, e.g., be known by the second user equipment 50.

According to an embodiment, the first user equipment 100 may, e.g., be configured to transmit said other first signal to the second user equipment 50, which may, e.g., be received by the second user equipment 50 as said other second signal, so that the second user equipment 50 can estimate a phase ramp and a carrier phase depending on one or more differences between said other first signal and said other second signal, and so that the second user equipment 50 can estimate a round trip time and/or a distance between the first user equipment 100 and the second user equipment 50. Or, the first user equipment 100 may, e.g., be configured to transmit said other first signal to the second user equipment 50, so that the phase ramp and the carrier phase, which have been estimated by the first user equipment 100 and that have been transmitted from the first user equipment 100 to the second user equipment 50, can be combined with the first signal, and so that the second user equipment 50 can estimate a round trip time and/or a distance between the first user equipment 100 and the second user equipment 50.

In an embodiment, the first user equipment 100 may, e.g., be configured to determine whether or not to transmit said other first signal to the second user equipment 50 for positioning depending on a synchronization configuration.

According to an embodiment, the first user equipment 100 may, e.g., be configured to transmit a further first signal to two or more other user equipments as a groupcast message or as a broadcast message for positioning, wherein the further first signal may, e.g., be a reference signal or may, e.g., be a control signal or may, e.g., be a data signal and/or the data signal may, e.g., be a reconstructed data signal. The reconstructed data signal may, e.g., be reconstructed from a decoded data signal. For example, the first user equipment 100 may, e.g., be configured to decode the data signal to obtain the decoded data signal and may, e.g., be configured to generate the reconstructed data signal from the decoded data signal.

In an embodiment, the first user equipment 100 may, e.g., be configured to transmit said further first signal synchronized with the two or more other user equipments such that each of the first user equipment 100 and of the two or more other user equipments may, e.g., be configured to transmit its further first signal at different times and/or on different sub-carriers, and/or on different carriers and/or in different resource pools, and/or may, e.g., be configured to use a different orthogonal sidelink positioning reference sequence.

According to an embodiment, the first user equipment 100 may, e.g., be configured to transmit a message to one or more other user equipments, to which the first user equipment 100 wants to measure the distance, for allowing the one more other user equipments to determine a timing of reception. The first user equipment 100 may, e.g., be configured to receive a message from each of the one or more other user equipments, transmitted by each of the one or more other user equipments after a predetermined time period after receiving the message from the first user equipment 100. Moreover, the first user equipment 100 may, e.g., be configured to measure a time of arrival and/or an angle of arrival for the message from each user equipment of the one or more other user equipments. Furthermore, the first user equipment 100 may, e.g., be configured to determine the distance information from the time of arrival and/or from the angle of arrival for the message from each user equipment of the one or more other user equipments.

In an embodiment, the first user equipment 100 may, e.g., be configured to transmit a message to one or more other user equipments, to which the first user equipment 100 wants to measure the distance, for allowing the one more other user equipments to determine a timing of reception and to adjust its transmitter timing depending on the timing of reception. The first user equipment 100 may, e.g., be configured to receive a message from each of the one or more other user equipments, transmitted by each of the one or more other user equipments after an individual time period after receiving the message from the first user equipment 100. Moreover, the first user equipment 100 may, e.g., be configured to measure a time of arrival for the message from each user equipment of the one or more other user equipments. Furthermore, the first user equipment 100 may, e.g., be configured to receive information on said individual time period from each user equipment of the one or more other user equipments. Moreover, the first user equipment 100 may, e.g., be configured to determine the distance information from the time of arrival for the message from each user equipment of the one or more other user equipments depending on the information on said individual time period of each user equipment of the one or more other user equipments.

According to an embodiment, the first user equipment 100 may, e.g., be configured to transmit a request for a transmission for positioning to the second user equipment 50.

In an embodiment, the first user equipment 100 may, e.g., be configured to transmit the request via two stage sidelink control information.

According to an embodiment, the first user equipment 100 may, e.g., be configured to transmit said request depending on a proximity of the second user equipment 50 or of another user equipment and/or depending on a defined use case and/or depending on an environmental condition.

In an embodiment, the first user equipment 100 may, e.g., be configured to receive from the second user equipment 50 position information on a position of the second user equipment 50 from a Global Navigation Satellite System.

According to an embodiment, the first user equipment 100 may, e.g., be configured to switch on continuous sidelink positioning.

In an embodiment, the first user equipment 100 may, e.g., be configured to another unit of the wireless communication system information on at least one or more of
that the first user equipment 100 may, e.g., comprise the capability for simultaneous transmission and/or reception from one or more antenna ports,
that the first user equipment 100 comprises the capability to coherently transmit and/or receive on more than one frequency sub-bands,
an antenna configuration indicating at least one of the separation between the antenna elements, and the bandwidth of each transmission and/or reception.

According to an embodiment, the first user equipment 100 may, e.g., be configured to transmit and/or to receive sidelink configuration information.

In an embodiment, the sidelink configuration information may, e.g., comprise information on at least one of:
a positioning reference signal frequency pattern,
a positioning reference signal time pattern,
a periodicity of a positioning reference signal transmission,
a bandwidth part configuration,
an antenna port,
a feedback channel indicator,
a source identifier,
a destination identifier,
a zone identifier,
a communication range,
a carrier phase.

According to an embodiment, the first user equipment 100 may, e.g., be configured to use a lookup table or a codebook comprising sidelink configuration information. The first user equipment 100 may, e.g., be configured to receive one or more sidelink configuration parameters which specify a selection of the sidelink configuration information being stored in the lookup table or in the codebook.

In an embodiment, the first user equipment 100 may, e.g., be configured to receive and/or to transmit one or more reports on a distance between the first user equipment 100 and the second user equipment 50 and/or on time difference of arrival information and/or on round trip time information to one or more other user equipments.

According to an embodiment, the first user equipment 100 may, e.g., be configured to receive and/or to transmit the one or more reports on a physical sidelink feedback channel and/or on a physical sidelink shared channel and/or on a physical sidelink control channel.

In an embodiment, the first user equipment 100 may, e.g., be configured to receive a request for transmitting the positioning information via the sidelink. Moreover, the first user equipment 100 may, e.g., be configured to transmit the positioning information via the sidelink in response to said request.

According to an embodiment, the first user equipment 100 may, e.g., be configured to stop transmitting the positioning information via the sidelink, if a condition of one or more conditions may, e.g., be fulfilled. The one or more conditions comprise at least one of the following:
a target user equipment is located within a predefined zone or within a predefined geographical area,
a predefined time duration after a predefined event has occurred has not been lapsed,
a predefined threshold indicating a signaling load due to the ranging measurement sharing has been exceeded,
a quality of service or a priority is lower than a predefined threshold.

In an embodiment, the first user equipment 100 may, e.g., be configured to transmit or to receive a positioning measurement report comprising information on at least one of a user equipment identifier, a measurement identifier, a type of measurement, a value of the measurement.

According to an embodiment, the first user equipment 100 may, e.g., be configured to transmit or to receive the positioning measurement report periodically, and/or depending on a threshold, and/or depending on an event.

In an embodiment, the first user equipment 100 may, e.g., be configured to select said one of the two or more positioning concepts to determine the positioning information depending on at least one of the following:
a positioning accuracy requirement,
one or more environmental conditions,
a latency,
a delay until a positioning result is available,
a reliability to provide the positioning result,
an error propagation of a positioning measurement precision,
one or more user equipment-specific conditions,
one or more user equipment-specific capabilities,
one or more radio conditions,
one or more environmental conditions.

According to an embodiment, the first user equipment 100 may, e.g., be configured to transmit a request for support in positioning to another user equipment, being different from the first user equipment 100 and from the second user equipment 50, via the sidelink, and may, e.g., be configured to receive and to process information from said other user equipment in positioning. And/or, the first user equipment 100 may, e.g., be configured to transmit a request for support in positioning to another user equipment, being different from the first user equipment 100 and from second user equipment 50, via the sidelink, and may, e.g., be configured to support said other user equipment in positioning on receipt of the request.

In an embodiment, the first user equipment 100 may, e.g., be a first vehicular user equipment.

According to an embodiment, the second user equipment 50 may, e.g., be a second vehicular user equipment.

FIG. 7 illustrates a system according to an embodiment. The system comprises the first user equipment 100 for determining positioning information of FIG. 6 and a second user equipment 50, which transmits a signal to the first user equipment 100 for determining the positioning information according to an embodiment.

According to an embodiment, the second user equipment 50 may, e.g., be implemented as the first user equipment 100 of FIG. 6.

In an embodiment, the system may, e.g., further comprise a further apparatus which may, e.g., be a location management server or which may, e.g., implement a location management function. The further apparatus may, e.g., be configured to transmit a request for positioning information to the first apparatus. The first apparatus may, e.g., be configured to transmit the positioning information to the further apparatus to respond to the request for positioning information.

In the following, a positioning system for the sidelink, PC5 based positioning architecture according to particular embodiments is described.

V2X communication in general denotes UEs that communicate directly with each other over the sidelink aka PC5 interface. This includes the special cases vehicle-to-vehicle (V2V), vehicle-to-infrastructure (V2I) and vehicle-to-pedestrian (V2P).

V2V relates to scenarios, where vehicles communicate directly with other vehicles.

V2I relates to scenarios, where vehicles communicate with other entities of the wireless communication network, i.e. roadside units (RSU) like traffic lights, traffic signs, etc. An RSU may have a functionality of a BS or of a UE, depending on the specific network configuration.

V2P relates to scenarios, where vehicles communicating with further road users, e.g. pedestrians or biker.

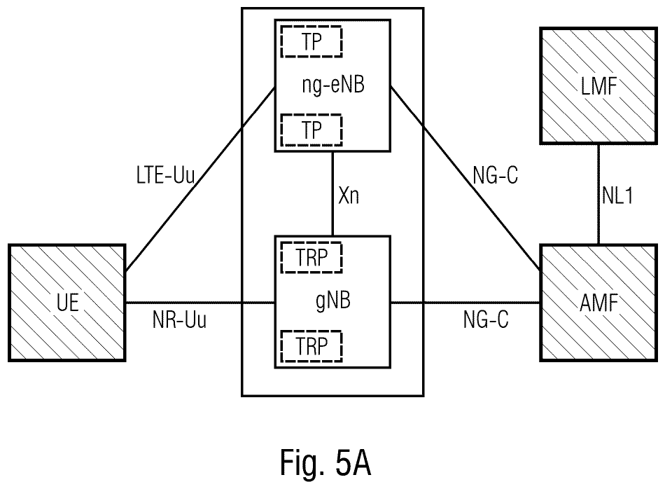

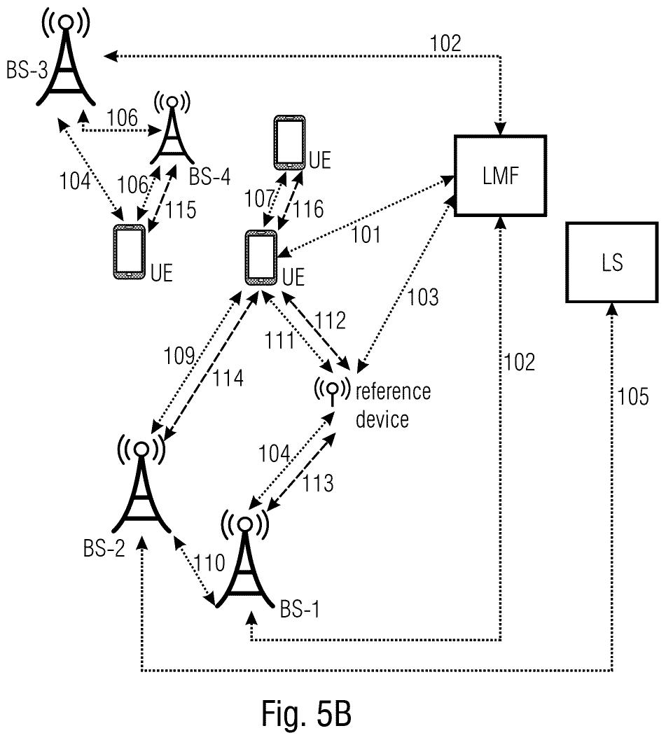

In some embodiments, a significant difference to the known positioning wireless network architecture shown in FIG. 5A is that a wireless architecture based on sidelink are able to perform positioning also without coverage, i.e. without involvement of the network. That means, positioning measurements, algorithms, processing and functions are deployed on the UEs, only, in particular, if the sidelink is operated in mode 2 out-of-coverage.

In other words one or multiple UEs have to be selected to collect measurement data from so called target UEs, e.g., the UEs whose position should be determined, and anchor UEs, e.g., UEs involved in the positioning to support e.g. absolute positioning, and computing the position(s) of the anchor UEs. This functionality, comparable to the LMF in the known architecture in FIG. 5A, may be mapped on an anchor UE, a target UE or even distributed over a multitude of anchor and/or target UEs. A special case thereof is ranging which is the distance determination between a target and an anchor UE.

However that does not mean that network support is completely excluded. If a UE involved in positioning is in cell coverage, it may use its Uu interface in parallel and off-load positioning functions to the network, i.e. using the known positioning system.

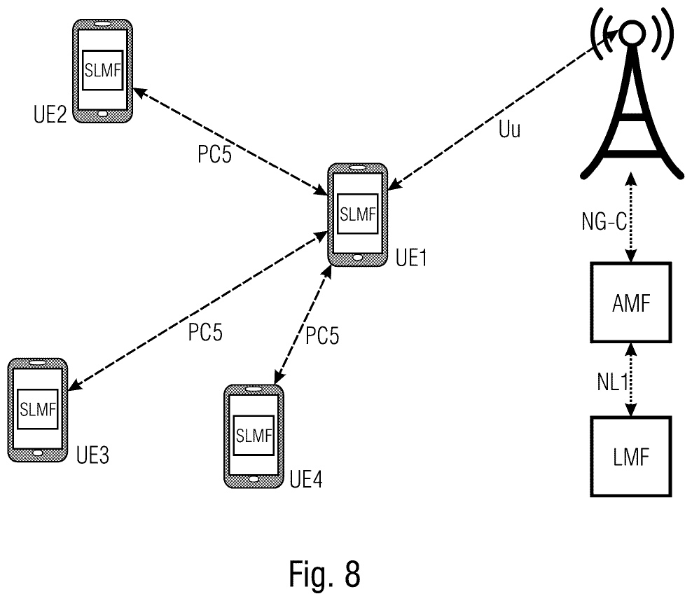

FIG. 8 shows a possible positioning architecture based on the PC5 interface (sidelink) according to some embodiments. Each UE may, e.g., be able to conduct one or more of the following:
to generate reference signals, which can be switched on and off, e.g., triggered, activated or deactivated
to perform measurements on reference symbols from other UEs,
to process the measurements, to compute positioning information,
to execute a function comparable to LMF, e.g., sidelink LMF (SLMF), to report (either broadcast, groupcast or unicast) full or partial, preprocessed or fully processed positioning indications or results,
to share positioning related measurements on the sidelink, to select/resect the appropriate positioning technique,
to assist other UEs on the sidelink in positioning.

In addition, UEs using mode 1 or mode 2 in coverage may combine both positioning method(s), i.e. positioning results based on the Uu interface with sidelink based positioning method(s), e.g. to further increase the accuracy, when required, e.g. by the use case.

In the following, reference signals of particular embodiments are described in more detail.

Reference Signals, RS(s), are described herein may, e.g., be reference signals transmitted from an apparatus being a base-station, a UE, a reference device or a positioning TRP/TP or the like. RSs may be used to enable sidelink-based positioning relying on the measurements on the sidelink or sidelink-assisted positioning. The positioning measurements may be used to enable the positioning methods described above.

5G-NR reference signals (RS) may, e.g., be considered as sequences mapped to subcarriers in the frequency domain, e.g., on a two dimensional resource grid. RS may, e.g., be known to the transmitter (TX) and the receiver (RX).

For sidelink positioning, e.g., any kind of the following PC5 specific RS may, e.g., be used:
demodulation reference signals (DMRS),
a sequence transported by the Physical Sidelink Feedback Channel (PSFCH), synchronization signals, e.g. S-PSS/S-SSS,
dedicated positioning reference signals (PRS) introduced to sidelink, i.e. sidelink PRS (SPRS),
a phase-tracking reference signal (PT-RS, in FR2),
channel state information reference signals (CSI-RS).

The sequence that constitutes the PSFCH may, e.g., transport a single bit and thus can be used for distance measurements at limited performance for 5G-NR sidelink by e.g. determining the round-trip time of a HARQ response or simply treating it as a reference signal in the same way as an SPRS.

DMRS may, e.g., be designed to estimate the channel impulse response where each single pulse represents the relative time delay of a path.

A Channel State Information Reference Signal (CSI-RS) is a reference signal used for channel state estimation/sounding and reporting between a transmitter and a receiver UE.

The Phase Tracking Reference Signal (PT-RS) is used as a reference signal for phase noise compensation.

The Sidelink Primary/Secondary Synchronization Signal (S-PSS/S-SSS) together with PSBCH are parts of the Sidelink Synchronization Signal Block (S-SSB) and used for the SL synchronization.

SPRS are not yet, i.e. as of release 17, specified for sidelink. Embodiments enhance the 5G NR sidelink PC5 interface with Sidelink Positioning Reference Symbol(s) SPRS(s). SPRS(s) may, e.g., be derived from known DL-PRS or UL-SRS specified in release 16 for Uu based positioning. A significant difference between DL-PRS and UL-PRS is that while DL-PRS uses pseudo-random sequences, UL-SRS is based on “constant amplitude zero autocorrelation” (CAZAC) sequences.

The introduction of sidelink PRS (SPRS) according to embodiments may, e.g., enable the sidelink for relative time delay and thus distance measurements like RTT as well as differential methods like TDOA. In the following the abbreviation SPRS is synonym for any of the above reference signals or any other signals not mentioned here.

If a UE is in coverage and is able to establish a parallel Uu interface connection, the corresponding RSs may be used with DL, UL or DL and UL positioning measurements for the above mentioned DL methods or UL and DL methods in combination with sidelink. RS(s) may be referred to those skilled in the art as DL-PRS, UL-SRS, LTE PRS, SPRS or any downlink, uplink or sidelink reference signal used for the purpose of positioning.

In the following, bandwidth enhancement according to embodiments is described.

Sidelink carrier aggregation (CA) is suitable to overcome the band limitation of sidelink carriers, i.e., high precision sidelink time delay measurements, which are the basis for positioning and ranging, can be achieved by evaluating sufficient bandwidth, e.g. by combining SPRS from multiple carriers. Consequently, distance measurements have to rely on SPRS on fragmented spectrum. For example, any kind of CA can be used, i.e. contiguous and non-contiguous intra-band CA as well as in case of 5G NR inter-band CA, since it provides four operating bands ranging from sub GHz to up to 6 GHz. This allows to spread SPRS over a bandwidth in the order of several GHz for high precision of positioning.

Now, a reference signal transmitted/received on a fragmented spectrum is considered.

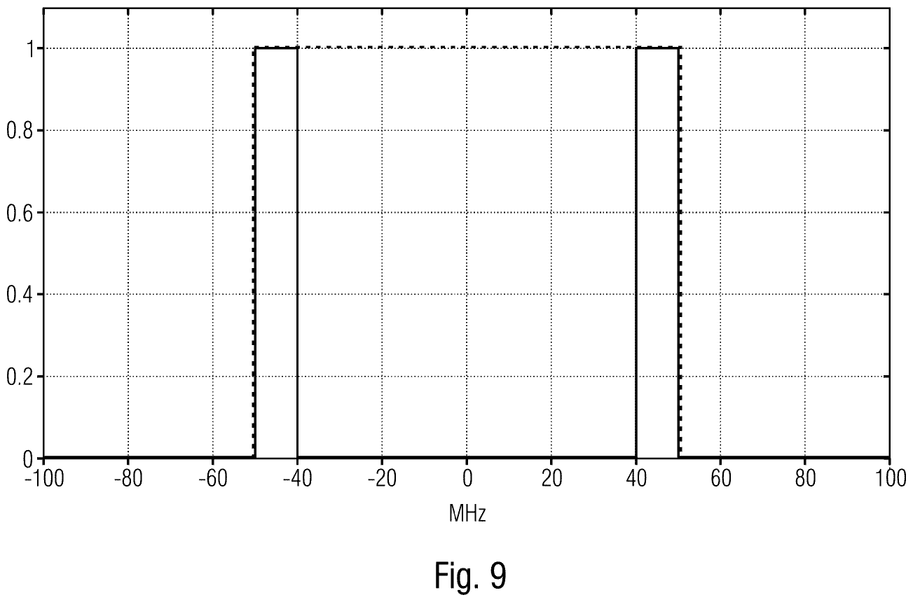

The bandwidth required for a certain accuracy does not have to be completely occupied by SPRS as one block. The same accuracy can be achieved if the bandwidth is partly occupied and SPRS are spread over the whole spectrum. For example, if a 100 MHz bandwidth is needed, two 10 MHz carriers may, e.g., be placed at the ends of the spectrum are sufficient as illustrated in FIG. 9.

FIG. 9 illustrates 100 MHz spectrum in a block with two 10 MHz carriers at the ends of the 100 MHz spectrum according to an embodiment. The dashed box represents a 100 MHz carrier, the solid boxes represent two 10 MHz carriers placed at the outermost edges, i.e. 90 MHz apart.

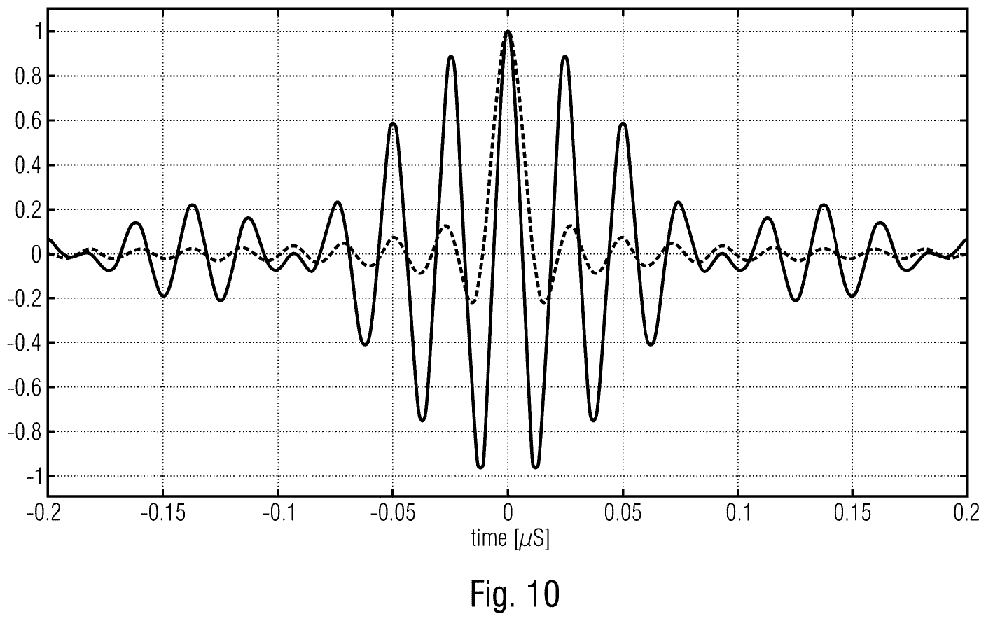

The corresponding cross-correlation functions are shown in FIG. 10. In particular, FIG. 10 illustrates cross-correlation functions of two 10 MHz carriers at the ends of 100 MHz and a 100 MHz carrier according to an embodiment. The cross-correlation function of a 100 MHz carrier is shown as dashed line. The solid line is the cross-correlation function of the two 10 MHz carriers separated by 90 MHz. The comparison of the highest peak reveals about the same pulse width with a slightly smaller pulse for the fragmented spectrum. That means, the positioning accuracy is roughly the same, possibly slightly better for the fragmented spectrum.

A fragmented spectrum can be realized by multiple component carriers (CC) or multiple resource pools or multiple Bandwidth parts (BWP). The multiple component carriers may, e.g., be realized intra-band, contiguous or intra-band, non-contiguous or inter-band.

In particular, inter-band CA may, e.g., provide the most enhancement of the accuracy. For example, for 5G NR sidelink currently, i.e. as of release 17, the operating bands n14, n79, n38 and n47 are specified. For example, the spectra of n38 and n47 are spaced apart by more than 2 GHZ, n14 and n47 even 5 GHZ. This would allow an accuracy in the order of cm.

Sidelink carrier aggregation in different bands may, e.g., be applied to licensed bands only, or may, e.g., be applied to unlicensed bands only, or may, e.g., be applied to any combination of carriers from licensed and unlicensed bands.

It should be noted that since in the current specification only one BWP can be active on the UE side and the sidelink resource pool is identical to the BWP, multiple BWP on the sidelink are in the current specification not possible in one carrier. Some of the embodiments overcome this restriction.

In the following, coherency of a fragmented spectrum is considered.

Phase coherence may, e.g., be needed to achieve the theoretical highest positioning precision. A distance measurement may, e.g., be based on a time delay measurement which translates into a phase ramp in the frequency domain. In case of a fragmented spectrum phase coherence means that the phase ramp continues within the spectral parts and the gaps in between as a straight line. Even if the spectral fragments are far apart, like inter-band carriers from low to ultra-high bands, this may, e.g., be ensured, if all clocks like mixer and sampling frequencies used by a receiver are derived from a single central reference oscillator. Since all clocks and frequencies are derived by PLLs they can be exactly locked to each other despite of different clock translation factors. Since those factors are exactly known the phase ramp can be determined over the whole frequency range occupied by the distributed spectral fragments.

Coherency is not mandated by 3GPP and is thus vendor specific. It can, however, be regarded as a capability, if the UE platform is designed, accordingly.

In the following, irregular placement is described.

In embodiments, the SPRS does not need to occupy all resource elements (RE) of a carrier. According to some embodiments, the SPRS may, e.g., be more or less sparsely spread over one carrier or multiple carriers. The positioning accuracy is determined by the spectral distance of the outer-most REs used as SPRS.

As illustrated in FIG. 10, the sparse distribution of the SPRS on multiple carriers with smaller bandwidth creates a cross-correlation function with side-peaks beside the main peak. Their pulse widths correspond to the spectral spread and their amplitudes are shaped by an envelope according to the bandwidth of a single carrier. This could cause ambiguities due to noise or too long distance.

If phase-differences between the carriers are evaluated, a trade-off between maximum distance of sub-carriers carrying SPRS and the unambiguous area has to be found. Especially for large frequency distance between those carriers, the corresponding positioning may suffer ambiguities. Therefore it is proposed to use some sub-carriers close to each other in order to achieve a larger unambiguous range. This is may, e.g., be achieved if the SPRS is mapped to REs with an irregular pattern.

In the following, particular embodiments are described with respect to the carrier phase. A high-precision accuracy of time delay measurements is achieved by taking the carrier phase into account. Generally speaking the phase rotation from transmitter to the receiving antenna is depending on the signal frequency and the distance between the both nodes.

Now, multiple frequencies are considered.

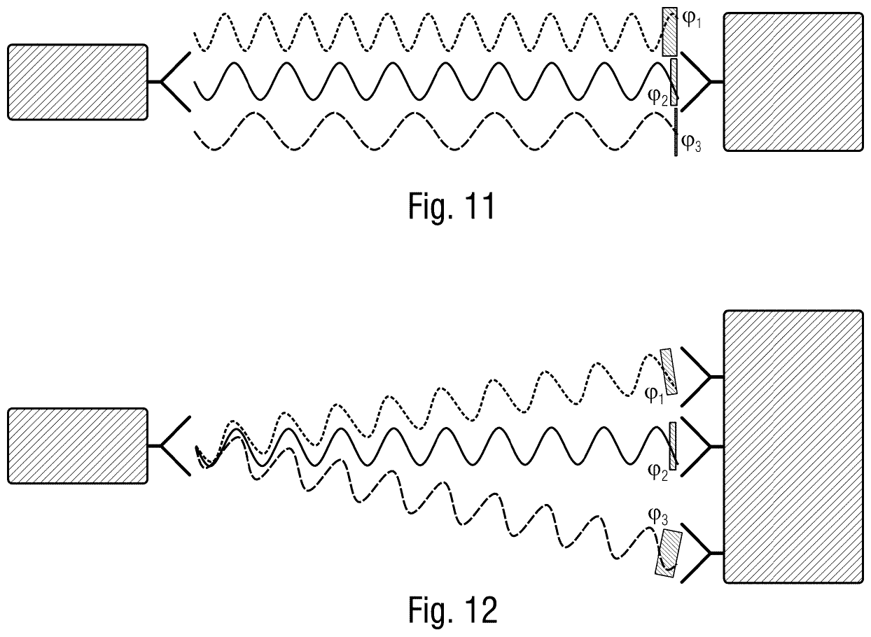

In a particular embodiment, multiple frequencies (either distributed or a single signal with sufficient bandwidth) may, e.g., be used and the received phases may, e.g., be exploited yielding information about the distance in wavelength (see FIG. 11). The OFDM modulation of a sidelink is a perfect waveform to exploit the carrier phase, since it provides a multitude of different frequencies by the sub-carriers.

FIG. 11 illustrates receiving phases due to different carrier frequencies according to an embodiment.

In the following, a single path is considered. Assuming a single propagation path, e.g., LOS (line of sight), a simple model of the carrier phase can be derived for the OFDM waveform. The spectrum of an OFDM symbol may, e.g., be described by

$$S ( ω ) = {\sum }_{k = 0}^{M - 1} δ ( ω - p ( k ) \cdot Δω ) \cdot {a}_{k} ,$$

where αₖ are the samples of a SPRS of length M, δ(ω) is the Dirac impulse in the frequency domain, Δω the sub-carrier spacing (SPS) and p(k) a placement function that determines the positions of the SPRS samples to corresponding sub-carriers. Inverse Fourier Transform into the time domain yields the time signal s(t) of the OFDM symbol. The transmit signal is obtained after upconversion to the radio frequency ω₀ by

$${s}_{T X} ( t ) = s ( t ) \cdot {e}^{j ( {ω}_{0} t + {φ}_{T} )} ,$$

where φ_{T} is an unknown constant phase of the upconverter, i.e. mixer in the TX (transmitter). This signal arrives the receiver with a time delay τ, thus

$${s}_{R X} ( t ) = {s}_{T X} ( t - τ ) = s ( t - τ ) \cdot {e}^{j ( {ω}_{0} ( t - τ ) + {φ}_{T} )} = s ( t - τ ) \cdot {e}^{j ( {ω}_{0} t + {φ}_{T} )} \cdot {e}^{- j {ω}_{0} τ}$$

Assuming perfect synchronization the received signal is downconverted to baseband with the mixer frequency ω₀

$$r ( t ) = {s}_{R X} ( t ) \cdot {e}^{- j ( {ω}_{0} t + {φ}_{R} )} = s ( t - τ ) \cdot {e}^{j ( {φ}_{T} - {φ}_{R} )} \cdot {e}^{- j {ω}_{0} τ} ,$$

where φ_{R} is an unknown constant phase of the downconverter, i.e. mixer in the RX (receiver). The Fourier Transform back to the frequency domain gives

$$R ( ω ) = S ( ω ) \cdot {e}^{j Δ φ} \cdot {e}^{- j {ω}_{0} τ} \cdot {e}^{- j ω τ} .$$

The second phase term is ambiguous by a multiple of 2π and thus can be further reduced, i.e.

$${e}^{- j {ω}_{0} τ} = {e}^{- j 2 π \cdot ⌊ {ω}_{0} τ / 2 π ⌋} \cdot {e}^{- j {ω}_{0} τ m o d 2 π} = {e}^{- j 2 π \cdot N} \cdot {e}^{- j {ω}_{0} τ m o d 2 π} = {e}^{- j {ω}_{0} τ m o d 2 π} .$$

Δφ has to be reduced in the same way. As can be seen the phase term ω₀τ consists of the two factors
1. an unknown arbitrary integer multiple N of 2π, which corresponds to the maximum integer multiple of the wavelength smaller than the distance between TX and RX,
2. the remainder. i.e. modulo, of ω₀τ versus 2π

As can be further seen, only the latter of the two can be measured from the receive signal. The cross-correlation with the replica of the SPRS is simply a multiplication with its complex conjugate. It has the purpose to eliminate any phase introduced by the SPRS. With that and introduction of the reduced phase terms the final result is

$${R}_{SS} ( ω ) = {\vert S ( ω ) \vert}^{2} \cdot {e}^{- j Δ φ m o d 2 π} \cdot {e}^{- j {ω}_{0} τ m o d 2 π} \cdot {e}^{- j ω τ} .$$

Now, the time delay can be determined from the two phase terms ω₀τ mod 2π and ωτ, assuming that the unknown phase Δφ can be eliminated by suitable means, like synchronization, coherency, or phase differences which will be described further below.

The term ω₀τ mod 2π is known as carrier phase and provides a high accuracy in fractions of the wavelength. Assuming the standard band n47 for V2X services at 5.9 GHZ the wavelength is about 5 cm. Thus, the carrier phase provides the potential of accuracies in the sub-cm if not mm for sidelink.

In the following, multi path is considered.

The single path model above can be extended for multipath,

$${R}_{SS} ( ω ) = {\vert S ( ω ) \vert}^{2} \cdot {e}^{- j Δ φ m o d 2 π} \cdot {\sum }_{paths l} {e}^{- j {ω}_{0} {τ}_{l} m o d 2 π} \cdot {e}^{- j ω {τ}_{l}} ,$$

where τₗ is the delay of path l. The problem to solve is to estimate the individual terms in the sum of the form

$${e}^{- j ( {τ}_{l} ω + {φ}_{0 , l} )}$$

Suitable estimators may, e.g., be employed, for example, LMS (least mean squares), AR (autoregressive) processes, Prony's method or the MUSIC algorithm.

In the following, distance estimation with carrier phase(s) is described.

As mentioned above the drawback of carrier phase is the ambiguity of the distance measurement by an unknown multiple of the wavelength. This ambiguity, however, can be resolved by the second phase term ωτ which is a phase ramp depending on the time delay and whose length depends on the bandwidth spanned by the SPRS. This phase ramp transformed to the time domain yields a time domain cross-correlation pulse as illustrated in 4 and in case of a fractional spectrum according to FIG. 9 a time domain cross-correlation function as in FIG. 10.

That means a high precision distance measurement can be achieved by estimating an equation of line αω+b=τₗω+φ_{0,l} for each path from the cross-correlation R_{SS} (ω), i.e. estimating its slope α=τₗ, from the phase ramp and the carrier phase from the y-intercept, i.e. b=φ_{0,l}.

The measurement of the carrier phase b allows to estimate a fraction of the distance

$${d}_{c , l} = d mod {λ}_{0} = c \cdot \frac{{φ}_{0 , l}}{{ω}_{0}} .$$

within a wavelength with high precision, where λ₀ is the carrier wavelength and c the speed of light.

The estimation of the phase ramp, in principle, only requires two frequencies. E.g., in OFDM terminology, at least two subcarriers are needed to estimate the slope. For example, assuming two adjacent subcarriers with spacing Δω, the time delay is given by the phase difference between the two sub-carriers. φ₁ be the phase measured from a path in the cross-correlation R_{SS}(ω) on the first and φ₂ on the second sub-carrier. The time delay estimate is then

$$τ = \frac{{φ}_{2} - {φ}_{1}}{Δ ω} .$$

and the distance is

$$d = c \cdot τ = c \cdot \frac{{φ}_{2} - {φ}_{1}}{Δ ω} .$$

The phase ramp estimation is based on the phase term Δωτ while the carrier phase estimation is based on the term ω₀τ. Since Δω is much lower than ω₀ the phase ramp estimation is less ambiguous. However, due to the same reason, it is also less sensitive than the carrier phase estimation. In other words ω₀ can be regarded as a much higher leverage than Δω that causes higher ambiguity but also a higher accuracy, since errors in the phase measurement have a much lower relative impact.

Therefore the phase ramp estimation is used to determine the integer multiple of the carrier wavelength λ₀=2πc/ω₀ that fits into the distance,

$$N = ⌊ d / {λ}_{0} ⌋ = ⌊ \frac{{φ}_{2} - {φ}_{1}}{2 π} \cdot \frac{{ω}_{0}}{Δ ω} ⌋ .$$

With the two estimates of the phase ramp and carrier phase the distance is estimated by

$$d = N \cdot {λ}_{0} + {d}_{c}$$

The confidence of the estimation of N can be improved considerably if the phase difference pairs from all or a subset of adjacent sub-carriers with SPRS are computed and averaged. Generally, any pair of SPRS samples can be used, i.e. adjacent and non-adjacent. However, it may be considered that an upper limit for an unambiguous distance estimation, and thus N, exists, depending on the frequency spacing of the sub-carriers. This upper limit is defined by

$$Δ ω τ < 2 π .$$

Solving for τ and converting into the distance yields the maximum resolvable distance is

$${d}_{max} = c \cdot \frac{2 π}{Δ ω} = \frac{c}{Δ f}$$

That means, the smaller the frequency spacing of the SPRS samples, the higher the maximum distance that can be resolved. For example, if the sub-carrier spacing is 30 KHz and all sub-carriers of an OFDM symbol would be used for SPRS the maximum unambiguous distance would be 10 km. Since sidelink operates at distances of several 100 m no limitation exists for ranging or time delay. That means, SPRS can be mapped at distances of several sub-carriers apart without causing any problems. That allows to reuse typical resource mappings like DL-PRS or UL-SRS on the Uu interface.

It should be clear to persons skilled in the art that estimation of N can not only be done by the above mentioned simple algorithm. In other embodiments, other concepts, for example, one or more of the concepts described above.

In the following, distributed antenna systems are considered.

High precision positioning can not only be achieved with high bandwidth. In some embodiments, multiple antennas may, e.g., be used, for example, if sufficient bandwidth is not available.

Prerequisite for this is, that at least the receive channels can be considered group wise coherent to each other, e.g. by demodulating groups of receive channels with the same local oscillator. The accuracy is proportional to the largest antenna spacing, i.e. the aperture expansion. In other words accuracy can be either achieved by providing sufficient bandwidth or by deploying spatially distributed antenna elements with an equivalent spacing.

Another option is to use multiple, spatially distributed antennas and exploit the fact, that the slight differences in the distances between transmitter and the spatially distributed antennas produce characteristic phase patterns at the coherent receive channels.

FIG. 12 illustrates receiving phases due to different receive antenna positions according to such an embodiment.

For the distributed antenna approach at least a 2-dimensional array may, e.g., be employed. The accuracy depends on the expansion of the antenna distribution. In general, the edge-elements with the largest spacing (equivalent to the carriers at the spectrums edges) provide the highest sensitivity and therefore the highest accuracy.

The highest precision can be achieved, if the transponder is located directly in front of the antenna array. In this case the effective aperture has the largest expansion possible and a position change of the transmitter has the largest impact.

Common approaches for this tasks are beamforming approaches like the well-known DAS Beamformer (delay-and-sum beamformer). Nevertheless it is possible to evaluate the phases, or more specifically the phase-differences between coherent receive signals directly [1].

In the following, a combination of carrier aggregation and distributed antenna systems according to embodiments is described.

By combining the approaches of carrier aggregation and distributed antenna systems and by evaluating distributed aggregated carriers and distributed antennas simultaneously, an even higher accuracy can be achieved. One possible implementation may, e.g., be to conduct a phase based range measurement as described above, and then combine this with an angle determination from the phase front sampling with the distributed antennas to get the full information of the positions for two or more devices relative to each other. In a multi antenna system the following measurement data is available:
phase differences due to used bandwidth and distance for each antenna (coarse localization, range determination)
carrier phase due to distances (considering also small distance differences between the spatial distributed antennas) and carrier frequency for each antenna and frequency (fine localization, range and angle determination).

The bandwidth provides a large portion of the resolution in the longitudinal direction, while the distributed antennas enable the resolution in the lateral direction. Furthermore, the resolution in lateral direction (e.g., by the distributed antennas) dominates the accuracy for close-range applications, while at greater distances, the longitudinal resolution (due to the distributed carriers or due to the carrier phase measurements) dominates the accuracy. This is due to the fact, that the dilution of precision in lateral direction depends on the distance between the transmitter and the receiver, as an angular range translates to a larger area of possible positions the further the position is from the vertex of the angle. For the longitudinal resolution, the dilution of precision stays almost the same, if the signal power in relationship to the noise floor is sufficient.

In the following, a usage of recursive approaches for carriers and antennas with large distances according to some embodiments is described.

As described above, the carrier phase rotation is ambiguous, if the expected distance between transponder and receiver is in the range of multiple signal wavelengths. In order to achieve high accuracy, large frequency or antenna spacing is desirable, but such frequencies and antenna distributions are not always able to provide unambiguous measurement information in the whole measurement area. Recursive approaches, like the Kalman Filter, help to resolve these ambiguities by considering the last position as well.

In other words, the distance to a moving device can be tracked by regular measurements. The subsequent measurements may, e.g., be done in time intervals that are short enough that the distance measurement does not change by more than a wavelength. For the correct distance a knowledge of one initial point may, e.g., still be needed once. This could be provided by sidelink ranging, but also any other positioning technology, like GNSS or on-board sensors.

From distance tracking the mutual radial speed can easily be estimated. If only the radial speed is to be estimated, an initial point is not needed.

In the following, synchronization is considered.

According to a first plurality of embodiments, synchronization may apply one or more or all of the following concepts:

Sidelink synchronization may, e.g., use one or more of three different concepts (see [4]), for example, GNSS, and/or gNB, and/or SSB from another UE.

If the sidelinks of a group of UEs are mutually synchronized the above mentioned unknown phase Δφ is eliminated.

For example, if a distance between two UEs shall be measured, the following cases can occur, in an embodiment, a first UE transmits SPRS and the second UE estimates the distance from the phase ramp and carrier phase.

In another embodiment, both UEs transmit SPRS and the distance estimation involves both UEs using a round trip time (RTT) estimation based on the phase ramp and carrier phase.

In a further embodiment, a first UE transmits SPRS, the second UE estimates the distance from the phase ramp and carrier phase and signals the results to the first UE

Which of the two UEs transmits the SPRS and which estimate the distance may, e.g., depend on the synchronization source of the UEs.

For example, a UE1, in the following called S-UE, is synchronizing to the SSB (synchronization signal block) of another UE2 acting as synchronization reference (SR), in the following called SR-UE. UE1 cannot estimate the distance to the SR-UE (UE2) if the SPRS is transmitted from the SR-UE (UE2). The reason is that the S-UE (UE1) synchronizes to the SSB with the same propagation delay from SR-UE (UE2) to S-UE (UE1) as the SPRS. In other words, the timing reference of UE1 is delayed due to the propagation delay of the SSB, thus the SPRS is received with virtually zero delay. Consequently, the phase ramp and carrier phase is zero. In this case a one-way ranging is not possible.

If, on the other hand, the S-UE transmits the SPRS the SR-UE can estimate the distance, since the phase ramp and carrier phase will represent the RTT of the distance. In this case a one-way ranging is possible.

If both UEs are S-UEs, the distance estimation would be impacted by the relative distances of the S-UEs, independent of if the synchronization reference is an SR-UE, a gNB or GNSS. In this case a one-way ranging is generally not possible.

In some embodiments, the choice of one-way or two-way ranging may, e.g., depend on a synchronization configuration.

Two-way ranging according to an embodiment may, e.g., be conducted in the following way: A first UE transmits a SPRS.

A second UE may, e.g., estimate the phase ramp and carrier phase on the SPRS.

The second UE may, e.g., apply the estimated phase ramp and carrier phase to an SPRS. In an alternative, the second UE does not apply the estimated phase ramp and carrier phase to the SPRS, but may, e.g., signal these measurement values to the first UE. The first UE can then include those measurement in the ranging computation.

The second UE may, e.g., transmit the SPRS modified by the estimated phase ramp and carrier phase at a defined delay known to the first UE. In an alternative, the second UE may, e.g., transmit the SPRS phase at a defined delay known to the first UE without modifying it by the estimated phase ramp and carrier phase.

The first UE may, e.g., estimate the phase ramp and carrier phase on the SPRS from the second UE. In an alternative, the first UE may, e.g., combine the estimated phase ramp and carrier phase on the SPRS from the second UE with the measurements signaled by the second UE.

The first UE may, e.g., estimate a RTT (round trip time) and may, e.g., derive the distance between first and second UE

In the following, groupcast and broadcast ranging is described.

Ranging of multiple UEs may, e.g., be done in groupcast or broadcast mode by a SR-UE. Assuming a group of UEs with one SR-UE, i.e. all other UEs synchronize to the SSB of the RS-UE, in this case, all S-UEs in the group transmit SPRS that are orthogonal to each other. The SR-UE may, e.g., estimate the distance to all S-RS.

Orthogonalization of the SPRS may, e.g., be ensured by coordinating the S-UEs such that, e.g., each S-UE may, e.g., transmits its SPRS at different times, e.g., each S-UE may, e.g., transmit its SPRS on different sub-carriers, carriers or resource pools, e.g., each S-UE may, e.g., use a different orthogonal or quasi-orthogonal SPRS sequence (this sequence could be scrambled with the source ID of the S-UEs and/or the group ID of sidelink group).

According to a second plurality of embodiments, synchronization may apply one or more or all of the following concepts:

Sidelink synchronization may use 3 different references [4]
GNSS
gNB.
SSB from another UE

If the sidelinks of a group of UEs are mutually synchronized the above mentioned unknown phase Δφ is eliminated.

If a distance between two UEs shall be measured, the following cases can occur.
A first UE transmits SPRS and one or a multitude of second UE(s) receive the SPRS, estimate the arrival time(s) or time delay(s) from e.g. the phase ramp and carrier phase, or any other measurement, and signal those results to the first UE. The first UE is called target UE and the second UE(s) anchor UEs.
   The first UE may then compute its position based on the results.
   Alternatively, in case of insufficient capabilities, parts of the positioning may be computed by one or a multitude of the second UE(s) and signaled to the first UE.
One or a multitude of second UE(s) transmit(s) SPRS, a first UE receives the SPRS, estimates the arrival time(s) or time delay(s) from e.g. the phase ramp and carrier phase, or any other measurement. The first UE is called target UE and the second UE(s) anchor UEs.
   The first UE may then compute its position based on those results.
   Alternatively, in case of insufficient capabilities, the first UE may offload parts of the positioning computation to one or a multitude of the second UEs by signaling the measurement results to the respective second UEs. The computation result is then signaled back to the first UE.
Both UEs transmit SPRS and the distance estimation involves both UEs using a round trip time (RTT) estimation based on the phase ramp and carrier phase

The behavior of the time delay measurement between two UEs depends on the synchronization source of the UEs and which transmits the SPRS. The following cases have to be distinguished:
1. UE1 is the synchronization source and transmits SSB
   a. UE2 synchronizes to the SSB of UE1 and receives the PRS from UE1. In this case UE2 would measure a time delay of 0 since it synchronizes to the SSB with the same propagation delay from UE1 to UE2 as the SPRS. In other words, the timing reference of UE1 is delayed due to the propagation delay of the SSB, thus the SPRS is received with virtually zero delay. Consequently, the phase ramp and carrier phase is zero.
   b. UE2 synchronizes to the SSB of UE1 and transmits the SPRS. In this case UE1 receives the SPRS and measures a time delay equal to the RTT since UE2 synchronizes to the SSB with the propagation delay from UE1 to UE2, thus transmits the SPRS with this delay which are received by UE1 with a further delay from UE2 to UE1. That means, UE2 measures the double distance between the two UEs which corresponds to one-way ranging.
2. The synchronization source is either GNSS or a gNB

In this case the time delay measured by UE2 based on SPRS transmitted by UE1 depends on the positions of the two UEs and the synchronization source.

Consequently, in case of ranging the choice of one-way or two-way ranging depends on the synchronization configuration. If the first UE transmitting SPRS is also the synchronization source, any second UE can determine its distance to the first UE with one-way ranging. Otherwise, two-way ranging is needed.

Two-way ranging would be done in the following way:
A first UE transmits SPRS
A second UE receives the SPRS and estimates the phase ramp and carrier phase on the SPRS.
The second UE applies the estimated phase ramp and carrier phase to an SPRS
   In an alternative, the second UE does not apply the estimated phase ramp and carrier phase to the SPRS, but signals these measurement values to the first UE. The first UE can then include those measurement in the ranging computation.
The second UE transmits the SPRS modified by the estimated phase ramp and carrier phase at a defined delay known to the first UE
   In the alternative the second UE transmits the SPRS phase at a defined delay known to the first UE without modifying it by the estimated phase ramp and carrier phase.
The first UE estimates the phase ramp and carrier phase on the SPRS from the second UE
   In the alternative the first UE combines the estimated phase ramp and carrier phase on the SPRS from the second UE with the measurements signaled by the second UE.
The first UE estimates RTT and derives the distance between first and second UE

The above described two-way ranging may be extended to double-sided RTT.

With respect to groupcast or broadcast ranging, ranging of multiple UEs can be done in groupcast or broadcast mode. Assume a group of anchor UEs with one target UE whose distances to the anchor UEs shall be determined. If the target UE is the synchronization source, i.e. all other UEs synchronize to the SSB of the target UE, and all anchor UEs in the group transmit SPRS that are orthogonal to each other. The target UE can estimate the distance to all anchor UEs directly with one-way ranging.

In all other cases two-way ranging is needed.

Orthogonalization of the SPRS can be ensured by coordinating the anchor UEs such that.
Each anchor UE transmits its SPRS at different times
Each anchor UE transmits its SPRS on different sub-carriers, carriers or resource pools
Each anchor UE uses a different orthogonal or quasi-orthogonal SPRS sequence (this sequence could be scrambled with the source ID of the S-UEs and/or the group ID of sidelink group)

Considering sidelink positioning procedures, sidelink positioning procedures and configuration may, e.g., be controlled by the sidelink location management function (SLMF) shown in FIG. 8. SMLF can be regarded as a light weight LMF executed on a UE.

In the following, location modes are considered. Sidelink can be used for ranging, relative and absolute positioning. The most important mode is ranging, i.e. determine the 1-dimensional distance between e.g. vehicles. If sidelink is operated in mode 2, e.g. OOC, two-way-ranging may be applied. Assuming that a UE1, e.g., UE1 in FIG. 8, wants to measure the distance to one or multiple UEs (e.g. UE2 to UE4 in FIG. 8) the procedure may, e.g., be as follows:

A UE1, in the following called the ranging UE, may, e.g., transmit a message that addresses the UEs, in the following called the ranged UEs, to which it wants to measure the distance

UE1 may, e.g., transmit a signal, for example some kind of RS, like a SPRS.

Each ranged UE that has been addressed for ranging (e.g. UE2 to UE4) may, e.g., receive the RS and determines the accurate timing of reception.

Each ranged UE may, e.g., adjust its transmitter timing according to the measured reception timing.

The ranged UEs may, e.g., transmit some kind of RS, like a SPRS, after a defined time period. This time period between reception and transmission of RSs used for positioning is known to the ranging UE. I.e. it is either a specified default value or has been configured by a host UE or in case of coverage by the network.

The ranging UE may, e.g., receive the RSs and measures the exact time of arrival.

From the time difference between its RS transmission and the RS receptions from the ranged UEs considering the known processing times, the ranging UE may, e.g., compute the distances to the ranged UEs.

Alternatively, the procedure for a UE1 to measure the distance to one or multiple UEs, the procedure, when the period between reception and transmission of RSs is unknown, may, e.g., be as follows:

UE1, in the following called the ranging UE, may, e.g., transmit a message that addresses the UEs, in the following called the ranged UEs, to which it wants to measure the distance.

UE1 may, e.g., transmit a signal, for example some kind of RS, like a SPRS.

Each ranged UE that has been addressed for ranging (e.g. UE2 to UE4) may, e.g., receive the RS and determines the accurate timing of reception.

Each ranged UE may, e.g., adjust its transmitter timing according to the measured reception timing.

The ranged UEs may, e.g., transmit some kind of RS, like a SPRS, after a defined time period. This time period between reception and transmission of RSs used for positioning is measured individually by each ranged UE.

The ranging UE may, e.g., receive the RSs and measures the exact time of arrival.

Each ranged UE may, e.g., report its measured time period between reception and transmission of RS used for positioning to the ranging UE, e.g. via PSSCH or PSCCH or PSFCH.

From the time difference between its RS transmission and the RS receptions from the ranged UEs considering the known processing times and the reported time periods of the ranged UEs, the ranging UE may, e.g., compute the distances to the ranged UEs.

In the following, a conditional sidelink positioning using a positioning request, an initiation of sidelink positioning and configuring reference symbols are considered.

Precise sidelink positioning may, e.g., not be required continuously or under all conditions, but may depend on defined conditions or options. Whenever these conditions are fulfilled, sidelink positioning should be initiated, e.g. a Positioning Request and/or an (initial/update/modification) configuration of positioning reference signals and/or reporting (e.g., of measurements, relative (distance)/absolute position) may, e.g., be send.

Since positioning is done to a particular distant UE the SPRS may, e.g., only be allocated on the resources selected by this UE for transmission. Since it is not guaranteed that a distant UE transmits, it is proposed to specify a request mechanism.

In other words, if a UE wants to measure the distance to another UE, it should be able to request a transmission for positioning. This can also be a resource with SPRS, only.

An exemplary request mechanism may, e.g., be comprise that a request is sent via the two stage SCI. For instance the 2^{nd} stage SCI comprises a Layer 1 source ID and other information. By using this information, the ranged UE may, e.g., select a RS configuration and also the resources to transmit the RS.

In another embodiment, the receiver of such a request may, e.g., process positioning based on the received message. In its response to inform the transmitter about the positioning result, the receiver may, e.g., include its available position information, e.g. GNSS, and add more information in addition to SPRS to assist the UE in its self-localization.

Possible conditions, when sidelink positioning should be initiated and/or reference symbols should be configured may, e.g., be one or more of the following conditions:

A proximity of UEs, e.g. vehicular UEs or VRU in proximity (e.g. distance between V-UEs, e.g., based on zones (e.g. same or adapted approach as for HARQ response) or based on higher layer information, e.g. CAM (cooperative awareness messages) or approaching UEs (e.g. based on CAM) or based on GNSS positioning data or sensor data occurs.

A defined use case occurs/defined event(s) occur, e.g., overtaking, dense traffic, reported accidents or emergencies.

One or more environmental conditions are fulfilled, e.g. to adapt the number of reference symbols. For example, speed (Doppler), e.g. depending on the UEs (vehicle's) speed more reference symbols may, e.g., be required. Interference, traffic load, (vehicle) density e.g. with increasing interference more reference symbols might be required. Further conditions may, e.g., apply.

In the following, continuous sidelink positioning is considered. Sidelink positioning may, e.g., also be switched on continuously, e.g. for vehicular UEs Capability Transfer: (e.g. 1. LPP capability transfer).

The UE may, e.g., sends its capabilities to the network entity (e.g. an LMF), where the capability consists an indication of at least one of the following:

A simultaneous transmission and/or reception from one or more antenna ports.

An ability to coherently transmit or receive on more than one frequency sub-bands, wherein the sub-bands may, for example, be multiple component carriers or multiple resource pools.

An antenna configuration indicates a separation between the antenna elements and/or indicates the bandwidth of each of the transmissions/receptions.

In the following, signaling on the sidelink is considered.

At first a positioning reference symbol configuration in sidelink according to particular embodiments is considered.

Sidelink positioning information based on reference symbols may, e.g., require a configuration or a sequence of reference symbols. Under cell coverage the RS resources and resource set configurations may, e.g., be provided to the target UE on a higher layer interface such as LPP from the LMF or possibly from a serving cell over an RRC or MAC-CE or DCI interface. In out-of-coverage the configuration may, e.g., be provided by any UE via sidelink. A predefined default configuration may, e.g., be used as long as that UE was not in coverage in the past and thus could not get a configuration from the network. The UE or a reference device may, e.g., be configured for a measurement of one or more SPRS resources. An index to reference symbol configuration may, e.g., be used to transmit the reference symbols configuration, for example, based on a code book or look-up table.

A reference symbol configuration may, e.g., be transmitted on the physical layer (PHY) using 1^{st} stage/2^{nd} stage SCI or RRC or MAC CE. In case of the physical layer, some bits, for example, two bits, in 1^{st} stage, may, e.g., be used to indicate the 2^{nd} SCI format, wherein for example, the 2^{nd} SCI format specific for sidelink positioning is comprised of one or more or all of the following parameters: a PRS frequency pattern, a PRS time pattern, a periodicity of a PRS transmission, a BWP configuration, an antenna port, a feedback channel indicator, a source ID, a destination ID, a zone ID, a communication range, carrier phase information.

Alternatively, the look-up table or codebook may, e.g., be (pre-) configured by the network. For this purpose, some bits, e.g., two bits, in existing 1^{st} SCI or 2^{nd} SCI may, e.g., be configured to indicate a code point and/or an index of a codebook or within a codebook or a look-up table, whereby the sidelink-based positioning parameters may, e.g., be transmitted to the intended receiver UEs.

In the following, sidelink measurement reports according to some embodiments are considered.

Measurement reporting may, e.g., be set up and/or configured based on conditions, for example, on a UE proximity or based conditions described above. Based on the distance between UEs, positioning reports may, e.g., be send to all or only to a subset of UEs, for example, as a groupcast. Reporting may, e.g., be limited to the UEs within the defined group.

The “positioning” report may, e.g., comprise the distance between the UEs for relative positioning (as final result) or any not final processed results (e.g. related to the phase shift) or an absolute UE position.

The example of a sidelink measurement report is indicated in the dashed box below:

Alternatively, the UE may, e.g., be configured to report multipath rich reporting of the channel between two UEs operating in sidelink. The UE may, e.g., choose to report a time difference of arrival (TDoA) between the reference UE and the second UE. The reference UE may, e.g., be selected based on certain criteria, for example, the UE synchronized to the most reliable timing source (e.g. GNSS or gNB) according to the (pre-configuration). One example could be that the reference UE may, for example, be a roadside unit, which is stationary and the other UE is the moving device (e.g. a vehicle), which could be measuring time difference of arrival to multiple third UEs, e.g. pedestrian unit. Alternatively, the UE in sidelink may, e.g., measure a time difference of arrival, which may, for example, be the time elapsed since receiving a certain reference signal to the time when the UE transmits a certain reference signal. Finally, the UE may, e.g., simply report the received time of arrival of a certain signal.

A particular signaling structure to report the above information according to a specific embodiment is shown below as an example in a non-limiting sense.

-- ASN1START
NR-SL-TDOA-SignalMeasurementInformation-r18 ::= SEQUENCE {

| | |
|---|---|
| sl-PRS-ReferenceInfo-r18 | SL-UE-ID-Info-r18, |
| nr-SL-TDOA-MeasList-r18 | NR-SL-TDOA-MeasList-r18, |

...
}
NR-SL-TDOA-MeasList-r18 ::= SEQUENCE (SIZE(1..nrMaxSlUEs-r18)) OF NR-SL-TDOA-MeasElement-
r18
NR-SL-TDOA-MeasElement-r18 ::= SEQUENCE {

| | |
|---|---|
| sl-UE-ID-r18 | INTEGER (0..MaxUEID), |
| nr-ARFCN-r18 | ARFCN-ValueNR-r15 |

OPTIONAL,

| | |
|---|---|
| nr-SL-PRS-ResourceID-r18 | NR-SL-PRS-ResourceID-r18 |

OPTIONAL,

| | |
|---|---|
| nr-SL-PRS-ResourceSetID-r18 | NR-SL-PRS-ResourceSetID-18 |

```
  OPTIONAL,
  nrCoherentResource-r18 ::= SEQUENCE {
```

| | |
|---|---|
| nr-ARFCN-r18 | ARFCN-ValueNR-r15 |

OPTIONAL,

| | |
|---|---|
| nr-SL-PRS-ResourceID-r18 | NR-SL-PRS-ResourceID-r18 |

OPTIONAL,

| | |
|---|---|
| nr-SL-PRS-ResourceSetID-r18 | NR-SL-PRS-ResourceSetID-r18 |

```
  OPTIONAL,
  } OPTIONAL -- CondCoherentCombining
```

| | |
|---|---|
| nr-TimeStamp-r18 | NR-TimeStamp-r18, |
| nr-RSTD-r16 | INTEGER (0..maxReportingRange), |
| nr-AdditionalPathList-r16 | NR-AdditionalPathList-r16 |

OPTIONAL,

| | |
|---|---|
| nr-TimingQuality-r16 | INTEGER (minQuality .. maxQuality) |
| nr-SL-PRS-RSRP-Result-r16 | INTEGER (0..126) |

OPTIONAL,
}
NR-AdditionalPathList-r16 ::= SEQUENCE (SIZE(1..MaxPathReport)) OF NR-AdditionalPath-r16
NR-AdditionalPath-r16 ::= SEQUENCE {

| | |
|---|---|
| nr-RelativeTimeDifference-r16 | INTEGER (0..maxReportingRange), |
| nr-PathQuality-r16 | INTEGER (minQuality .. maxQuality) OPTIONAL, |

...
}
-- ASN1STOP

In the particular signaling structure above, the SL-UE-ID-Info-r18 may, e.g., be the identifier that identifies the entity determining a relative range, an absolute range or a position. This may also take alternate forms like C-RNTI used in partial coverage or SL-RNTI or similar. In a particular example, the position computing entity may, e.g., be capable to associate the measurement back to the correct UE if an identifier in the value range of 0 to MaxUEID is used. The ARFCN, SL-PRS resource set and SL-PRS resource ID may, e.g., uniquely identify the resource used for measurement. The nrCoherentResource-r18 may, e.g., be conditionally/optionally present and is used to indicate that the measurement is obtained by combining the sidelink PRS transmitted in different bandwidth parts of two different component carrier. The nr-TimeStamp-r18 may, e.g., be a timestamp which is associated with the measurement and said timestamp may, e.g., be derived from the reference UE/sync source. The RSTD may, e.g., be the received signal time difference between the reference UE and the measured UE. Its quality, which may indicate the quality of estimate of the ToA, may, for example, be signaled. Finally, additional multipath components may, e.g., be reported and their associated qualities may be reported. Furthermore, the RSRP report may, e.g., be provided and this may, e.g., assist in selecting the spatial filter between the transmitter and receiver pair.

-- ASN1START
NR-SL-RTT-SignalMeasurementInformation-r18 ::= SEQUENCE (SIZE (1..nrMaxSlUEs-r18)) OF NR-SL-
RTT-MeasElement-r18
NR-SL-RTT-MeasElement-r18 ::= SEQUENCE {

| | |
|---|---|
| sl-UE-ID-r18 | INTEGER (0..MaxUEID), |
| nr-ARFCN-r18 | ARFCN-ValueNR-r15 |

OPTIONAL,

| | |
|---|---|
| nr-SL-PRS-ResourceID-r18 | NR-SL-PRS-ResourceID-r18 |

OPTIONAL,

| | |
|---|---|
| nr-SL-PRS-ResourceSetID-r18 | NR-SL-PRS-ResourceSetID-r18 |

```
  OPTIONAL,
  nrCoherentResource-r18 ::= SEQUENCE {
```

| | |
|---|---|
| nr-ARFCN-r18 | ARFCN-ValueNR-r15 |

OPTIONAL,

| | |
|---|---|
| nr-SL-PRS-ResourceID-r18 | NR-SL-PRS-ResourceID-r18 |

OPTIONAL,

| | |
|---|---|
| nr-SL-PRS-ResourceSetID-r18 | NR-SL-PRS-ResourceSetID-r18 |

```
  OPTIONAL,
  } OPTIONAL -- CondCoherentCombining
  referenceRespondResource-r18 ::= SEQUENCE {
```

| | |
|---|---|
| nr-ARFCN-r18 | ARFCN-ValueNR-r15 |

OPTIONAL,

| | |
|---|---|
| nr-SL-PRS-ResourceID-r18 | NR-SL-PRS-ResourceID-r18 |

OPTIONAL,

| | |
|---|---|
| nr-SL-PRS-ResourceSetD-r18 | NR-SL-PRS-ResourceSetID-r18 |

```
  OPTIONAL,
  }
```

| | |
|---|---|
| nr-TimeStamp-r18 | NR-TimeStamp-r18, |
| nr-UE-RxTxTimeDiff-r16 | INTEGER (0..maxReportingRange), |
| nr-AdditionalPathList-r16 | NR-AdditionalPathList-r16 |

OPTIONAL,

| | |
|---|---|
| nr-TimingQuality-r16 | INTEGER (minQuality .. maxQuality) |
| nr-SL-PRS-RSRP-Result-r16 | INTEGER (0..126) |

OPTIONAL,
}
NR-AdditionalPathList-r16 ::= SEQUENCE (SIZE(1..MaxPathReport)) OF NR-AdditionalPath-r16
NR-AdditionalPath-r16 ::= SEQUENCE {

| | |
|---|---|
| nr-RelativeTimeDifference-r16 | INTEGER (0..maxReportingRange), |
| nr-PathQuality-r16 | INTEGER (minQuality .. maxQuality) OPTIONAL, |

...
}
-- ASN1STOP

For the RTT measurement, the difference in time between the SL-PRS resource received and the SL-PRS resource transmitted may, e.g., be reported. The difference path difference (relative time difference) may, e.g., report the delay of the multipath component with respect to the initial path. The referenceRespondResource may, e.g., be the sidelink PRS resource which the UE has transmitted and the difference in time between receiving and transmitting the two resources is reported in nr-UE-RxTxTimeDiff-r16.

In the above measurement, it may, e.g., be assumed that the SL-PRS is configured in an analogous way to UL-PRS. It may, e.g., be possible that the UL-PRS transmitted by a UE may be treated as a sidelink positioning reference signal. In this case, the information in the description above to identify a SL resource may, e.g., be adapted to refer to an instant of uplink SRS resource uniquely.

In case the UE reports the ToA, the UE may, e.g., also report the reference UE or a reference TRP based on which the timing information is generated (i.e. the source of timing information). Compared to TDOA, except the TDOA, TOA may, e.g., be reported. The additional paths shall still be reported as difference to the first arrival path.

-- ASN1START
NR-SL-TDOA-SignalMeasurementInformation-r18 ::= SEQUENCE {

| | |
|---|---|
| sl-PRS-ReferenceInfo-r18 | SL-UE-ID-Info-r18, |
| nr-SL-TDOA-MeasList-r18 | NR-SL-TDOA-MeasList-r18, |

...
}
NR-SL-TDOA-MeasList-r18 ::= SEQUENCE (SIZE(1..nrMaxSlUEs-r18)) OF NR-SL-TDOA-MeasElement-
r18
NR-SL-TDOA-MeasElement-r18 ::= SEQUENCE {

| | |
|---|---|
| sl-UE-ID-r18 | INTEGER (0..MaxUEID), |
| nr-ARFCN-r18 | ARFCN-ValueNR-r15 |

OPTIONAL,

| | |
|---|---|
| nr-SL-PRS-ResourceID-r18 | NR-SL-PRS-ResourceID-r18 |

OPTIONAL,

| | |
|---|---|
| nr-SL-PRS-ResourceSetID-r18 | NR-SL-PRS-ResourceSetID-r18 |

```
  OPTIONAL,
  nrCoherentResource-r18 ::= SEQUENCE {
```

| | |
|---|---|
| nr-ARFCN-r18 | ARFCN-ValueNR-r15 |

OPTIONAL,

| | |
|---|---|
| nr-SL-PRS-ResourceID-r18 | NR-SL-PRS-ResourceID-r18 |

OPTIONAL,

| | |
|---|---|
| nr-SL-PRS-ResourceSetID-r18 | NR-SL-PRS-ResourceSetID-r18 |

```
  OPTIONAL,
  } OPTIONAL -- CondCoherentCombining
```

| | |
|---|---|
| nr-Timestamp-r18 | NR-TimeStamp-r18, |
| nr-TOA-r16 | INTEGER (0..maxReportingRange), |
| nr-AdditionalPathList-r16 | NR-AdditionalPathList-r16 |

OPTIONAL,

| | |
|---|---|
| nr-TimingQuality-r16 | INTEGER (minQuality .. maxQuality) |
| nr-SL-PRS-RSRP-Result-r16 | INTEGER (0..126) |

OPTIONAL,
}
NR-AdditionalPathList-r16 ::= SEQUENCE (SIZE(1..MaxPathReport)) OF NR-AdditionalPath-r16
NR-AdditionalPath-r16 ::= SEQUENCE {

| | |
|---|---|
| nr-RelativeTimeDifference-r16 | INTEGER (0..maxReportingRange), |
| nr-PathQuality-r16 | INTEGER (minQuality .. maxQuality) OPTIONAL, |

...
}
-- ASN1STOP

Now, sidelink channels used for positioning related information reporting according to some embodiments are considered.

One option to transmit positioning related information is the PSFCH (Physical Sidelink Feedback Channel), which is used from Rel-16 onwards to transmit HARQ feedback information. In an embodiment, the PSFCH may, e.g., be adapted to transmit either positioning relevant information only or positioning and feedback related information in combination.

For transmission of positioning relevant information, the PSFCH may, for example, be used without limitation to unicast or groupcast (i.e. for all cast types including broadcast) as originally foreseen for HARQ feedback, which is relevant for unicast and groupcast only.

Alternatively, other sidelink physical channels e.g. PSSCH or PSCCH may, e.g., be used for the transfer of positioning related information.

In the following, sharing of ranging measurement over the sidelink according to some embodiments is described.

A UE may, e.g., share ranging measurement or relative distances to another UE(s) or group of UE(s) through the sidelink when an explicit signaling request is received, or some condition(s) are triggered.

Either 1^{st} stage or the 2^{nd} SCI format in two-stage SCI signaling or both together or a MAC CE or RRC signaling may, e.g., convey the ranging measurement request, for example, for uni-cast and group-cast communications in the case of explicit signaling. For example, the first stage may, e.g., indicate a format of the second stage, wherein the second stage comprises at least the following information corresponding to a UE or a group of UE(s), namely a UE ID of corresponding UE, e.g., destination ID, and/or Group ID of corresponding UEs.

Alternatively, a sharing ranging measurement can be triggered or stopped, for example when at least the following conditions are met, namely, when a target UE is located within a zone or a geographical area; and/or for a specific time when a timer is configured; and/or a threshold indicating the signaling load due to the ranging measurement sharing is exceeded; and/or per quality of service or priority.

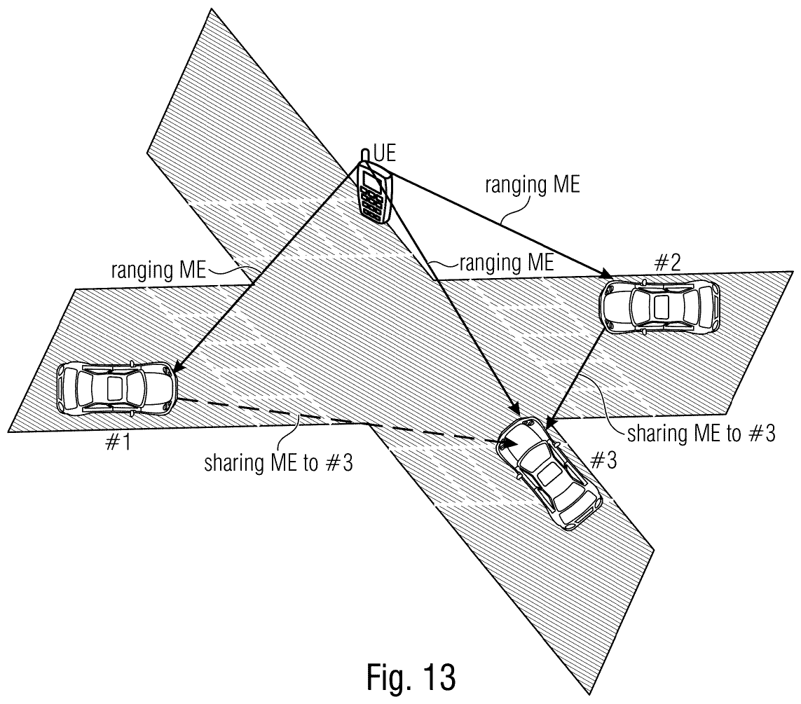

FIG. 13 shows an illustrative example of explicit or condition-based sharing ranging measurement according to an embodiment.

Ranging measurement may, e.g., be considered as an optional feature. For example, it may, e.g., be disabled or stopped when it is not configured or when a specific threshold indicates that the network's signaling load is reached. The feature or triggering threshold may, e.g., be configured by a higher layer signaling, e.g., RRC.

Optionally, a UE, which receives an explicit request for the ranging measurement, or when triggering conditions are met, may, e.g., share the ranging measurement by using 2^{nd} SCI of two-stage information or RRC or a MAC CE message to traverse the measurement.

A ranging measurement and an explicit request may, e.g., be transmitted on a configured resource pool or the same peer to peer resource pool for TX and RX or different resource pool for TX and RX, on a dedicated resource pool, or on an exceptional resource pool.

The SL positioning measurements may, e.g., be exchanged among UEs, for example, in form of RRC IEs (e.g. in Example 1 see field “SL_Pos_Meas”). The positioning measurement report may, for example, at least one of the following information for example, a UE ID, a measurement ID, a type of measurement, a value of the measurement, or any other information.

The SL positioning measurement report may, e.g., be exchanged between UEs directly or indirectly based on the at least one of following criteria, for example, on a periodic basis, on a threshold basis, on a event basis, on a request basis.

In the following, selection and re-selection of positioning techniques according to some embodiments are described.

V2X use cases comprise requirements to meet a defined positioning accuracy. Examples for these requirements are provided e.g. in [2], where e.g. lateral and/or longitudinal positioning accuracy is provided on a per use case basis. Depending on the automotive service level, e.g. changing from assisted to automated driving, these requirements may, e.g., be adapted.

To achieve this positioning accuracy, multiple sidelink and Uu based positioning techniques and combinations of positioning techniques may, e.g., be applied, for example, one or more of the above described positioning techniques. Each positioning technique or combination of positioning techniques is expected to achieve a certain positioning accuracy.

The achieved positioning results may, e.g., (in addition to accuracy) further need to fulfill additional requirements, for example, latency, the delay until the positioning result is available and reliability, e.g. of provisioning the positioning results (e.g. in time). The positioning accuracy of each positioning method may, e.g., be further impacted by multiple conditions (outside the positioning technique itself), for example, UE speed, antenna type, interference, UE type.

In addition, depending on the type of UE, high power consuming positioning methods may, e.g., be less appropriate e.g. for battery-based UEs. Opposite, the power consumption of vehicular mounted UEs may be not considered. Therefore, for example, the UE capabilities may, e.g., be considered in addition.

Considering the different aspects impacting the positioning accuracy, one or multiple of the following aspects may, e.g., be employed to select the appropriate positioning technique or combination of positioning techniques:
A positioning accuracy requirement (e.g. for a specific service or use case), wherein the accuracy may be further impacted by environmental conditions, e.g. due to bad weather conditions or higher speed the positioning accuracy may increase.
Further requirements on achieving the positioning results (in addition to accuracy), for example, a latency, the delay until the positioning result is available, and/or a reliability, e.g. packet error rate to provide the positioning result, and/or an error propagation of positioning measurement precision e.g. dilution of precision.
UE-specific conditions, e.g. UE-type, antenna type, battery type and level, UE capabilities
Radio conditions, for example, interference.
Environmental conditions, for example, speed, weather conditions (e.g. ice, snow, rain, sunshine) and further environmental conditions)

In an embodiment, a UE may, e.g., select an appropriate positioning technique (e.g. reference symbols, carrier aggregation, carrier phase) or a combination of positioning techniques based on the “Value/Index related to required positioning” of the mapping table (see Table 1) possibly in combination with further conditions (UE-specific, radio and environmental related) listed above.

TABLE 1
Example of mapping positioning characteristics
to a positioning index

| | | | | | |
|---|---|---|---|---|---|
| Value/Index | | Required | | Error propagation | |
| required | Required | latency | | of positioning | |
| positioning | positioning | (e.g. delay | Reli- | measurement | |
| accuracy) | accuracy | budget) | ability | precision | . . . |

1
2
3

Due to, e.g., changes of any of the aspects listed above, the positioning technique(s) may, e.g., need to be adapted or changed. For example, a re-selection/change of the positioning technique(s) may, e.g., be considered based on environmental conditions.

In the following, UE assisted positioning is considered.

At least for V2X use cases, different types of users and accordingly of UE types may, e.g., be distinguished. A major distinguishing factor is the type of battery/power supply used by the UE. For example, in V2X, there are vehicular UEs (V-UEs) connected to the battery of the vehicle and Vulnerable Road Users (VRUs) using battery-based smartphones.

To avoid energy consuming positioning methods for battery-based UEs, a VRU-UE may, for example ask/request another UE (e.g. vehicular UEs) via sidelink signaling for assistance in performing relative positioning. The position assistance asking to share positioning related information with other UEs (e.g. VRU-UEs) may, e.g., convey (pre) processed positioning information or may, e.g., convey a positioning report.

For example, the positioning information (e.g. distance between 2 UEs), e.g. UE1 and UE2 may, e.g., be determined by UE1 (e.g. a V-UE) and then shared with UE2 (VRU-UE) to, e.g., reduce the energy consumption of the VRU-UE.

A possible message flow for UE assisted positioning may, for example, be:
VRU-UE→V-UE: Request positioning information
V-UE→VRU-UE: Convey positioning information: (pre-) processed positioning information or positioning results

An option for signaling may, e.g., be to use an inter-UE coordination message as a container between two UEs to convey the positioning related information.

The request for positioning information as well as the positioning report may, for example, be conveyed using 2^{nd} stage SCI on the PHY or on RRC or as a MAC CE message.

The positioning report may, e.g., be requested explicitly (e.g. from VRU-UEs) or conditionally, when defined conditions are met, e.g. based on traffic load or approaching vehicles/roads (see also the conditions described above, when to share ranging measurements).

Some embodiments provide a more precise relative positioning, for example, between vehicles, even in out-of-coverage scenarios as the positioning methods of embodiment, apply on the sidelink. For safety critical scenarios, e.g., related to (partial) autonomous driving, determining the precise distance (relative positioning, ranging) e.g. between vehicles and further traffic participants realizes more safety. In embodiments, positioning accuracy is improved.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

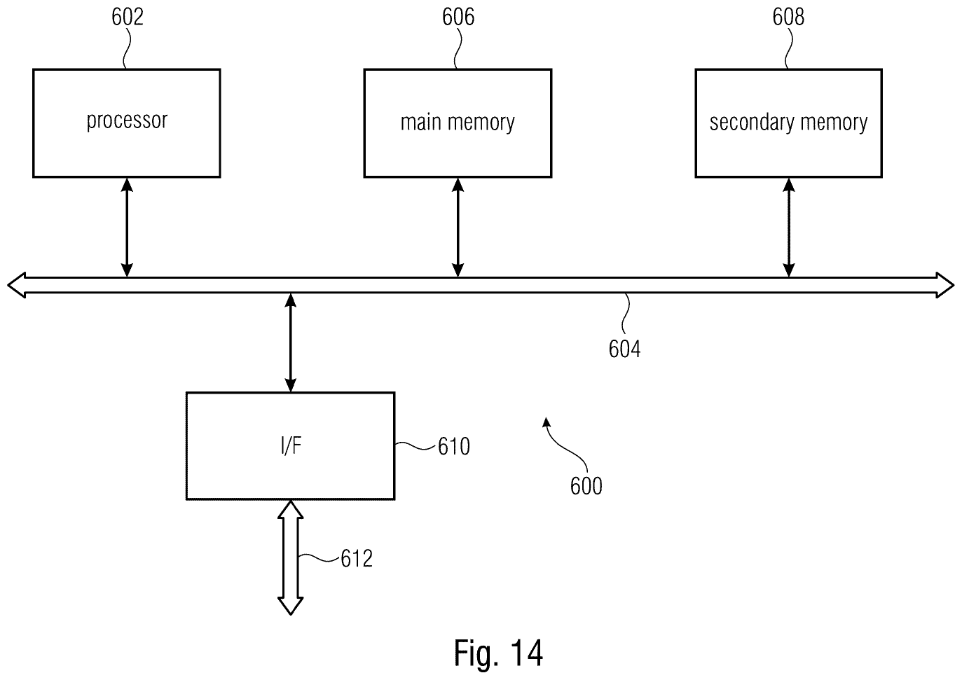

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 14 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] Lipka M., Sippel E. Vossiek M.: An Extended Kalman Filter for Direct, Real-Time, Phase-Based High Precision Indoor Localization, IEEE Access, 2019

[2] 3GPP TR 22.886: Technical Specification Group Services and System Aspects; Study on enhancement of 3GPP Support for 5G V2X Services (Release 16), V16.2.0, 2018-December

[3] 3GPP TS 38.305: Technical Specification Group Radio Access Network; NG Radio Access Network (NG-RAN); Stage 2 functional specification of User Equipment (UE) positioning in NG-RAN (Release 16), V16.6.0 (2021-September)

[4] 3GPP TS 38.331: Technical Specification Group Radio Access Network; Radio Resource Control (RRC) protocol specification (Release 16), V16.6.0 (2021-September )

ABBREVIATIONS

| Abbreviation | Definition |
|---|---|
| 3GPP | third generation partnership project |
| 5GC | 5G core network |
| BS | base station |
| CSI-RS | channel state information reference signal |
| DMRS | demodulation reference signal(s) |
| DOA | direction of arrival |
| E-CID | enhanced cell ID |
| eNB | evolved node b |
| E-SMLC | evolved serving mobile location center. |
| E-UTRA | evolved UMTS terrestrial radio access |
| gNB | next generation node-b |
| GPS | Global Positioning System |
| LMF | location management function |
| LMU | location measurement unit |
| LPP | LTE positioning protocol |
| LTE | Long-term evolution |
| NG | next generation |
| ng-eNB | next generation eNB |
| NG-RAN | either a gNB or an ng-eNB |
| NR | new radio |
| NRPPa | new radio positioning protocol a |
| OTDOA | observe time difference of arrival |
| PRS | positioning reference signal(s) |
| PTRS | phase tracking reference signal |
| QCL | quasi colocation |
| RAN | radio access network |
| RP | reception point |
| RSTD | reference signal time difference |
| RTOA | relative time of arrival |
| RTT | round trip time |
| SA | Standalone |
| SRS | sounding reference signal |
| TDM | Time Domain Multiplexing |
| TOF | time of flight |
| TRP | transmission reception point |
| RS | reference signal |
| QCL | quasi co-located |
| AoA | Angle of Arrival |
| AoD | Angle of Departure |
| PAS | Power Angular Spectrum |
| NR | New Radio |
| CA | carrier aggregation |
| CAM | Cooperative Awareness Message |
| DAS | distributed antenna systems |
| GNSS | Global navigation satellite system |
| OOC | Out-Of-Coverage |
| PSFCH | Physical Sidelink Feedback Channel |
| P-UE | Pedestrian UE: should not be limited to pedestrians, but |
| | represents any UE with a need to save power, e.g. electrical |
| | cars, cyclists, |
| RE | resource elements |
| SPRS, SL- | Sidelink positioning reference signals |
| V2X | Vehicle to anything |
| VRU | Vulnerable road user |
| V-UE | Vehicular UE |

1. A first user equipment of a wireless communication system,
wherein, after a second user equipment of the wireless communication system has transmitted a first signal, being a reference signal or a control signal or a data signal, to the first user equipment via a sidelink between the second user equipment and the first user equipment, the first user equipment is configured to receive said reference signal or said control signal or said data signal as a second signal from the second user equipment via the sidelink,
wherein the first user equipment is configured to determine positioning information depending on difference information, such that the difference information comprises information on one or more differences between the first signal, which has been transmitted by the second user equipment, and the second signal, which has been received by the first user equipment,
wherein the positioning information comprises information on a distance and/or a distance change between the first user equipment and the second user equipment and/or a position of the first user equipment and/or a position of the second user equipment and/or an angle which depends on the position of the first user equipment and on the position of the second user equipment.

2. The first user equipment according to claim 1,
wherein the first user equipment is configured to conduct one or more measurements on one or more reference symbols or control symbols or data symbols of the second signal to acquire information on at least one difference of the one or more differences between the first signal, which has been transmitted by the second user equipment, and the second signal, which has been received by the first user equipment,
wherein the first user equipment is configured to determine the positioning information depending on the information on said at least one difference.

3. The first user equipment according to claim 2,
wherein the first user equipment is configured to transmit information on the one or more measurements to the second user equipment via the sidelink.

4. The first user equipment according to claim 1,
wherein the first user equipment is configured to transmit information on the positioning information to the second apparatus or to one or more further apparatuses of the wireless communication system; or
wherein the first user equipment is configured to determine the positioning information using one of two or more positioning concepts selectable for the first user equipment, wherein the first user equipment is configured to select said one of the two or more positioning concepts to determine the positioning information.

5-8. (canceled)

9. The first user equipment according to claim 1,
wherein the first signal is one of
a PS5-specific reference signal,
a PS5-specific control signal,
a PS5-specific data signal,
a demodulation reference signal,
a signal sequence transported by a physical sidelink feedback channel,
a synchronization signal,
a sidelink positioning reference signal,
a phase-tracking reference signal,
a channel state information reference signal,
a sidelink positioning reference signal comprising one or more pseudo-random sequences and/or one or more constant amplitude zero autocorrelation sequences, and
a data transmit signal reconstructed from a decoded data signal.

10-11. (canceled)

12. The first user equipment according to claim 1,
wherein the first user equipment is configured to employ sidelink carrier aggregation using a plurality of frequency carriers.

13. The first user equipment according to claim 12,
wherein the first user equipment is configured to receive at least one of said reference signal and said control signal and/or said data signal via the plurality of frequency carriers via a fragmented spectrum such that there exist at least two frequency carriers of the plurality of frequency carriers, which are employed for transmitting said reference signal, and/or said control signal, and/or said data signal, wherein each two of the at least two frequency carriers are spaced apart from each other in frequency, and wherein no other frequency carriers of the plurality of frequency carriers exist, which are employed for transmitting said reference signal and/or said control signal and/or said data signal, and which are located between said two of the at least two frequency carriers.

14. The first user equipment according to claim 13,
wherein the fragmented spectrum comprises at least one of
multiple intra-band contiguous component carriers,
multiple intra-band non-contiguous component carriers,
multiple inter-band component carriers,
multiple resource pools,
multiple bandwidth parts.

15-16. (canceled)

17. The first user equipment according to claim 12,
wherein the first signal is sparsely spread among the plurality of frequency carriers.

18. The first user equipment according to claim 1,
wherein, for each frequency component of the two or more frequency components, the first signal depends on subcarriers of Orthogonal Frequency Division Multiplexing; or
wherein at least one of the one or more differences between the first signal and the second signal depends on a difference between a phase of the first signal, which has been transmitted by the second user equipment, and a phase of the second signal, which has been received by the first user equipment, wherein the first signal is the reference signal or is the control signal or is the data signal and/or the data signal is a reconstructed data signal.

19-20. (canceled)

21. The first user equipment according to claim 1,
wherein the first user equipment is configured to receive two or more signals as two or more second signals in two or more frequency components transmitted from the second user equipment of the wireless communication system via the sidelink between the first user equipment and the second user equipment, wherein the two or more frequency components comprise different center frequencies, wherein the second user equipment has transmitted said two or more signals as two or more first signals, wherein the two or more second signals comprise said second signal, and wherein the two or more first signals comprise said first signal, wherein the first user equipment is configured to determine the positioning information by determining difference information, wherein the difference information comprises information on one or more differences between the first signal and the second signal for each frequency component of the two or more frequency components, wherein, for each frequency component of the two or more frequency components, the first signal of said frequency component is a reference signal or is a control signal or is a data signal and/or the data signal is a reconstructed data signal; or
wherein the first user equipment is configured to determine the difference information by employing a recursive approach or a recursive filter; or
wherein the first user equipment is configured to determine the positioning information by employing the difference information and by additionally employing information from a Global Navigation Satellite System and/or by additionally employing on-board sensors of the first user equipment; or
wherein the first user equipment is configured to synchronize itself with the second user equipment by employing information from a Global Navigation Satellite System, or
wherein the first user equipment is configured to synchronize itself with the second user equipment by employing information from a base station, or
wherein the first user equipment is configured to synchronize itself with the second user equipment using a synchronization signal block transmitted by the second user equipment, or
wherein the first user equipment is configured to synchronize itself with the second user equipment using a synchronization signal block transmitted by another user equipment being different from the first user equipment and from the second user equipment.

22-30. (canceled)

31. The first user equipment according to claim 1,
wherein the first user equipment is configured to transmit another first signal to the second user equipment or to another user equipment to allow or support positioning, wherein the other first signal is a reference signal or is a control signal or is a data signal and/or the data signal is a reconstructed data signal.

32. The first user equipment according to claim 31,
wherein the first user equipment is configured
to estimate a phase ramp and a carrier phase depending on the difference information comprising the information on the one or more differences between the first signal, which has been transmitted by the second user equipment, and the second signal, which has been received by the first user equipment, and
to transmit said other first signal to the second user equipment, which is received by the second user equipment as another second signal; wherein the first user equipment is configured to transmit said other first signal by applying the phase ramp and the carrier phase, which has been estimated by the first user equipment, on said other first signal, or is configured to transmit information on the phase ramp and on the carrier phase to the second user equipment; wherein the first user equipment is configured to transmit said other first signal with a predefined time delay, wherein said predefined delay is known by the second user equipment.

33. The first user equipment according to claim 32,
wherein the first user equipment is configured to transmit said other first signal to the second user equipment, which is received by the second user equipment as said other second signal, so that the second user equipment can estimate a phase ramp and a carrier phase depending on one or more differences between said other first signal and said other second signal, and so that the second user equipment can estimate a round trip time and/or a distance between the first user equipment and the second user equipment, or
wherein the first user equipment is configured to transmit said other first signal to the second user equipment, which is received by the second user equipment as said other second signal, so that the phase ramp and the carrier phase, which have been estimated by the first user equipment and that have been transmitted from the first user equipment to the second user equipment, can be combined with the first signal, and so that the second user equipment can estimate a round trip time or a distance between the first user equipment and the second user equipment; or
wherein the first user equipment is configured to determine whether or not to transmit said other first signal to the second user equipment for positioning depending on a synchronization configuration.

34. (canceled)

35. The first user equipment according to claim 1,
wherein the first user equipment is configured to transmit a further first signal to two or more other user equipments as a groupcast message or as a broadcast message for positioning, wherein the further first signal is a reference signal or is a control signal or is a data signal and/or the data signal is a reconstructed data signal; or
wherein the first user equipment is configured to transmit a message to one or more other user equipments, to which the first user equipment wants to measure the distance, for allowing the one more other user equipments to determine a timing of reception, wherein the first user equipment is configured to receive a message from each of the one or more other user equipments, transmitted by each of the one or more other user equipments after a predetermined time period after receiving the message from the first user equipment, wherein the first user equipment is configured to measure a time of arrival for the message from each user equipment of the one or more other user equipments, and wherein the first user equipment is configured to determine the distance information from the time of arrival for the message from each user equipment of the one or more other user equipments; or
wherein the first user equipment is configured to transmit a message to one or more other user equipments, to which the first user equipment wants to measure the distance, for allowing the one more other user equipments to determine a timing of reception and to adjust its transmitter timing depending on the timing of reception, wherein the first user equipment is configured to receive a message from each of the one or more other user equipments, transmitted by each of the one or more other user equipments after an individual time period after receiving the message from the first user equipment, wherein the first user equipment is configured to measure a time of arrival and/or an angle of arrival for the message from each user equipment of the one or more other user equipments, wherein the first user equipment is configured to receive information on said individual time period from each user equipment of the one or more other user equipments, and wherein the first user equipment is configured to determine the distance information from the time of arrival and/or from the angle of arrival for the message from each user equipment of the one or more other user equipments depending on the information on said individual time period of each user equipment of the one or more other user equipments; or
wherein the first user equipment is configured to transmit a request for a transmission for positioning to the second user equipment; wherein the first user equipment is configured to transmit the request via two stage sidelink control information; or
wherein the first user equipment is configured to transmit a request for a transmission for positioning to the second user equipment; wherein the first user equipment is configured to transmit said request depending on a proximity of the second user equipment or of another user equipment and/or depending on a defined use case and/or depending on an environmental condition.

36-41. (canceled)

42. The first user equipment according to claim 1,
wherein the first user equipment is configured to transmit and/or to receive sidelink configuration information;
wherein the sidelink configuration information comprises information on at least one of:
a positioning reference signal frequency pattern,
a positioning reference signal time pattern,
a periodicity of a positioning reference signal transmission,
a bandwidth part configuration,
an antenna port,
a feedback channel indicator,
a source identifier,
a destination identifier,
a zone identifier,
a communication range, and
a carrier phase.

43-46. (canceled)

47. The first user equipment according to claim 1,
wherein the first user equipment is configured to use a lookup table or a codebook comprising sidelink configuration information, wherein the first user equipment is configured to receive one or more sidelink configuration parameters which specify a selection of the sidelink configuration information being stored in the lookup table or in the codebook; or
wherein the first user equipment is configured to receive and/or to transmit one or more reports on a distance between the first user equipment and the second user equipment and/or on time difference of arrival information and/or on round trip time information to one or more other user equipments; or
wherein the first user equipment is configured to receive a request for transmitting the positioning information via the sidelink, and wherein the first user equipment is configured to transmit the positioning information via the sidelink in response to said request; or wherein the first user equipment is configured to stop transmitting the positioning information via the sidelink, if a condition of one or more conditions is fulfilled, wherein the one or more conditions comprise at least one of the following: a target user equipment is located within a predefined zone or within a predefined geographical area, a predefined time duration after a predefined event has occurred has not been lapsed, a predefined threshold indicating a signaling load due to the ranging measurement sharing has been exceeded, a quality of service or a priority is lower than a predefined threshold; or
wherein the first user equipment is configured to transmit or to receive a positioning measurement report comprising information on at least one of a user equipment identifier, a measurement identifier, a type of measurement, a value of the measurement; or
wherein the first user equipment is configured to transmit a request for support in positioning to another user equipment, being different from the first user equipment and from the second user equipment, via the sidelink, and is configured to receive and to process information from said other user equipment in positioning, or
wherein the first user equipment is configured to transmit a request for support in positioning to another user equipment, being different from the first user equipment and from second user equipment, via the sidelink, and is configured to support said other user equipment in positioning on receipt of the request.

48-55. (canceled)

56. The first user equipment according to claim 1,
wherein the first user equipment is a first vehicular user equipment; or
wherein the second user equipment is a second vehicular user equipment.

57-60. (canceled)

61. A method, comprising:
after a second user equipment of a wireless communication system has transmitted a first signal, being a reference signal or a control signal or a data signal, to a first user equipment via a sidelink between the second user equipment and the first user equipment, receiving, by the first user equipment, said reference signal or said control signal or said data signal as a second signal from the second user equipment via the sidelink,
determining positioning information depending on difference information, such that the difference information comprises information on one or more differences between the first signal, which has been transmitted by the second user equipment, and the second signal, which has been received by the first user equipment,
wherein the positioning information comprises information on a distance and/or a distance change between the first user equipment and the second user equipment and/or a position of the first user equipment and/or a position of the second user equipment and/or an angle which depends on the position of the first user equipment and on the position of the second user equipment.

62. A non-transitory digital storage medium having stored thereon a computer program for performing a method of claim 61, when the computer program is carried out by a computer or a signal processor.
